(19) United States
(12) Patent Application Publication
(10) Pub. No.: US 2014/0144531 A1
(43) Pub. Date: May 29, 2014

(54) Assemble-on-Site Methane-Containing Biogas Collection System and Kit

(71) Applicants: Jill Hass, Ottawa (CA); Kevin Bailey, Ottawa (CA); James Henderson, Kanata (CA); Matthew Bailey, Ottawa (CA)

(72) Inventors: Jill Hass, Ottawa (CA); Kevin Bailey, Ottawa (CA); James Henderson, Kanata (CA); Matthew Bailey, Ottawa (CA)

(73) Assignee: Clearford Industries Inc., Ottawa, ON (CA)

(21) Appl. No.: 13/885,333

(22) PCT Filed: Nov. 7, 2011
(86) PCT No.: PCT/CA2011/050691

§ 371 Date: Oct. 31, 2013

Related U.S. Application Data
(60) Provisional application No. 61/415,293, filed on Nov. 18, 2010.

(51) Int. Cl. F16L 55/00

(52) U.S. Cl. CPC F16L 55/00
USPC 137/561 R

(57) ABSTRACT

The invention provides an assemble-on-site system for collecting biogas from digesting sewage. The system comprises a biogas deflection assembly configured and sized to fit a primary treatment unit; and a collection interface assembly operatively associated with the biogas deflection assembly and configured for connection to a biogas capture or collection system. When installed in the primary treatment unit, the biogas deflection assembly is substantially submerged and provides for the deflection of biogas to point(s) of biogas collection in the collection interface assembly. Also provided are components of the system and kits comprising one or more of the system components and assembly instructions.

### FIELD OF THE INVENTION

The present invention relates in general to the field of methane-containing biogas collection and in particular to an assemble-on-site system for collecting methane-containing biogas from digesting sewage, components thereof, and kits comprising components of the system.

### BACKGROUND

Digestion of sewage resulting in the generation of biogas occurs as naturally occurring micro-organisms break down and digest the sewage. In an aerobic environment, the end products of organic waste degradation are primarily CO₂ and H₂O. In an anaerobic environment, the intermediate end products of the waste degradation are primarily alcohols, aldehydes, organic acids and CO₂. In the presence of specialized microbes called methanogens, these intermediates are converted to the final end products of CH₄ and CO₂ with trace levels of H₂S.

The formation of methane by methanogens is called methanogenesis.

A simplified overall chemical equation for anaerobic digestion is given below:

C₆H₁₂O₆→3CO₂+3CH₄

Methanogens have also been shown to use carbon from other organic compounds such as formic acid, methanol, methylamines, dimethyl sulfide, and methanethiol.

Methane-containing biogas may be used for commercial or industrial applications but it may require further treatment with scrubbing and cleaning equipment (such as amine gas treatment) to bring the H₂S levels within acceptable levels and to reduce the quantity of siloxanes. Methane-containing biogas obtained from the process can be used for a variety of applications including electricity production and chemical synthesis of compounds including methanol, etc.

Over time, sewage generally settles into three substantially distinguishable layers 1) the bottom sludge layer that contains materials that have a higher specific gravity than water, are denser than water and are derived from much of the solid sewage; 2) the middle layer comprises liquid and suspended solids, these solids are typically very small organic materials that continue to be degraded while in the liquid layer; and 3) the scum layer, substantially composed of materials that have a lower specific gravity than water, such as grease, oil, and fats. Each layer defines a unique microenvironment with different characteristics that support a distinct consortium of microorganisms.

In the sludge layer of traditional septic tanks or clarifiers, methane-containing biogas production occurs as a result of anaerobic digestion. The biogas percolates out of the sludge layer, then through the middle liquid layer and then transits through the scum layer to collect in the headspace of the septic tank or clarifier. As populations of methane-oxidizing bacteria (methanotrophs) may be present in the scum layer, at least some of the methane component of the biogas is digested into carbon dioxide as it passes through the scum layer. Prior systems for biogas generation were not designed to maximize the capture or collection of methane-containing biogases resulting from the sludge breakdown and/or to prevent the interaction between methane-containing biogas and methanotrophs in the scum layer.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an assemble-on-site methane-containing biogas collection system and kit. In accordance with an aspect of the present invention, there is provided an assemble-on-site system for collecting biogas from digesting sewage comprising a biogas deflection assembly configured and sized to fit a primary treatment unit; and a collection interface assembly operatively associated with the biogas deflection assembly and configured for connection to a biogas capture or collection system; wherein, when installed in the primary treatment unit, the biogas deflection assembly is substantially submerged and provides for the deflection of biogas to point(s) of biogas collection in the collection interface assembly.

### BRIEF DESCRIPTION OF THE FIGURES

Embodiments of the invention will now be described, by way of example only, by reference to the attached Figures, wherein:

FIG. 1 illustrates various sizes of one embodiment of the assemble-on-site Biogas Collector (1000) installed in a single chamber primary treatment unit PTU (500). The biogas deflection assembly includes a biogas deflector (1100) which provides for the deflection of biogas bubbles towards the collection interface assembly (1200) and collection point(s) therein and the substantial segregation of the methane-consuming scum layer from both the methane-containing biogas producing sludge layer and point(s) of biogas collection. The collection interface assembly (1200) connects to a biogas collection system (1300). The biogas deflector (1100) is supported by a plurality of hanger assemblies (1400).

FIG. 2 shows the installation of two or more Biogas Collectors (1000), each with a biogas deflector (1100) and associated collection interface assembly (1200) in a single chamber PTU (500). The biogas interface assembly (1200) of each Biogas Collector operatively associated with a shared biogas collection system (1300) that exits the PTU at a single location. Each biogas deflector (1100) is supported by a plurality of hanger assemblies (1400).

FIG. 3 shows alternative views of one embodiment of the assemble-on-site methane-containing Biogas Collector detailing the biogas deflector (1100), hanger assemblies (1400), and a collection interface assembly (1200), installed in a PTU (500). The biogas deflector includes a modular frame work (1150, shown in part) and deflection paneling (1175). The illustrated collection interface assembly (1200) includes three points of biogas collection, each fitted with a collector (1166) that is operatively associated with the biogas tubing (1350) for connection to an external biogas collection system (not shown). Also shown are the inlet (510) and outlet (520) of the PTU (500).

FIG. 4 shows one embodiment of the assemble-on-site collector in situ detailing a modular framework (1150, shown in part), hanger assemblies (1400), a collection interface assembly (1200) with collector (1166) and cover (1172) and associated biogas tubing (1350), and deflection paneling (1175). Also shown are the PTU (500) and the inlet (510).

FIG. 5 is an alternate view of the embodiment of FIG. 4.

FIG. 6A to 6L illustrate various components of the assemble-on-site collection system of FIGS. 3 and 4. FIG. 6A illustrates a T-joint (1152) of the modular framework. FIG. 6B illustrates a locking slider (1154). FIG. 6C illustrates a clamp strap (1156). FIG. 6D illustrates a vertical tube connector (1158). FIG. 6E illustrates a horizontal tube end (1160). FIG. 6F illustrates a hook (1162). FIG. 6G illustrates an end cap (1164). FIG. 6H illustrates a collector (1166). FIG. 6I illustrates an EPDM gasket (1168). FIG. 6J illustrates deflection paneling (1175). FIG. 6K illustrates collector cover (1172) which can either be a formed or an extruded sheet. FIG. 6L illustrates the tubing component (1174) of the framing.

FIGS. 7A and 7B detail the hanger assembly illustrated in FIGS. 3 and 4. FIG. 7B is an exploded view of FIG. 7A and details a slider (1154) in position on the clamp strap (1156) which connects to the hanger upright. The hanger upright is formed from two vertical tube connectors (1158) and hanger tubing component (1174). If necessary, the upper vertical tube connector (1158) is fitted with a horizontal tube end support (1160) to provide support for biogas tubing. The lower vertical tube connector (1158) engages a hook (1162). FIG. 7C illustrates the installation of hanger assemblies (1400) into a PTU (500). Individual hanger assemblies can be locked to the PTU side wall by sliding the slider (1154) along the clamp strap (1156). The individual hanger assemblies may be pre-assembled or assembled on site.

FIG. 8 illustrates the modular framework of the embodiment illustrated in FIGS. 3 and 4 detailing the T-joint (1152) and tubing component (1174) of the frame work.

FIGS. 9A and 9B detail framework, deflection paneling (1175) attachment and installation of the deflection assembly. FIG. 9A illustrates attachment of the paneling material to the framework. The paneling is tie wrapped or glued to the assembled frame. FIG. 9B illustrates the installation of the deflection assembly. Hanger assemblies are assembled on site and positioned at appropriate locations on the PTU wall. Individual hanger assemblies are locked to the PTU wall by sliding the locking slider (1154) along the clamp strap (1156). The deflection assembly is then installed onto the hanger assemblies.

FIGS. 10A and 10B illustrate the collection interface assembly of the embodiment shown in FIG. 4. FIG. 10B shows an exploded view of the collection interface and associated biogas tubing (1302). The schematic details the various components of the collection interface assembly. The collection interface assembly (1200) includes modified hanger assemblies. In the modified hanger assemblies, locking sliders (1154) engage clamp straps (1156). The hanger upright is formed by the end cap (1164) and collector (1166). For the collector to be functional, a collector hole (1167) is provided in the collector cover (1172). In the illustrated embodiment, collection holes (1167) are provided at one end and in the center of the collector cover (1172). Collectors can however be mounted anywhere along the collector cover (1172) and may require the use of a connector (1165).

FIG. 11 details collector interface assembly (1200) installation above the biogas deflection assembly (1100).

FIG. 12 illustrates a PTU (500) configured for installation of two Biogas Collectors.

FIG. 13 illustrates custom components of a Biogas Collector of FIG. 12. Custom components include the outside wall brace (1180), inner wall brace (1182), punched HDPE strip (1184), hanger base (1186), side clip (1188), tee (1190), HDPE tree fastener (1192) and collector port assembly (1194).

FIG. 14 illustrates off the shelf components of the assemble-on-site collection system of FIG. 12. Off the shelf components include 3″ tube (1195), 2″ tube (1196), flexible tube (1197), 3″ end cap (1198) and nuts and bolts (1199).

FIG. 15 illustrates a biogas deflector of the embodiment of FIG. 12. For purposes of illustration, the biogas paneling is shown as transparent. Cross-bracing tubing (1193) is shown.

FIG. 16 illustrates a hanger assembly of the embodiment of FIG. 12 and shows outside wall brace (1180), inner wall brace (1182), punched HDPE strip (1184) and hanger base (1186). This hanger assembly configuration allows for lipped PTU lids. The hanger is adjustable to fit a range of PTU wall widths. Hanger length is also fully adjustable. The punched sheets maximize methane capture and allows for angle variability between hangers. To facilitate installation, hangers can be installed onto the biogas deflector prior to installation into the PTU.

FIG. 17 illustrates one embodiment of the biogas collection interface detailing the framing tube (1195) to which it is installed, the flexible biogas tubing (1197), mesh (1203) and membrane (1201). In the illustrated embodiment, the biogas collection interface includes a collection hub comprising a collector port (1194).

FIG. 18 is a schematic showing a side view of the biogas deflection assembly (1100) of FIG. 12 in a PTU (500). The biogas deflection assembly is sloped such that the end with the collector port (1194) is higher than the other end.

FIG. 19 details the slide wall brace of the hanger assembly of the embodiment of FIG. 12. The slide wall brace (1179) is formed from the outside wall brace (1180), inner wall brace (1182) and punched HDPE strip (1184). The individual components are held together using HDPE tree fastener (1192) or other appropriate fasteners. Either the outside wall brace or the inner wall brace may be configured with hooks (1183) to engage the HDPE strip (1184).

FIG. 20 details various views of the biogas deflectors (1100) of FIG. 12 with installed hanger assemblies (1400). Components of the framework are shown including cross-bracing tubing (1193).

FIG. 21 illustrates a PTU (500) with two Biogas Collectors. The two Biogas Collectors (1000) are shown in situ in a primary treatment unit (500). The biogas collection interface of each Biogas Collector is operatively associated with a shared biogas collection system (1310) and includes a biogas collection hub (2020) and a flexible tube crossing the hydrostatic line (liquid-gas interface). The shared biogas collection system (1310) is connected to an external gas pipe via flexible pipe (2010). Hanger assemblies (1400) and access hatch (1500) are also shown.

FIG. 22 illustrates the hanger assembly of FIG. 16 with optional support hook (1185) for supporting biogas tubing. Excess punched strip not removed.

FIG. 23 illustrates an exploded view of a biogas deflection assembly, hanger assemblies and collection interface of FIG. 21.

FIG. 24 details a biogas collection hub (2020). The illustrated biogas collection hub is a multi-component system comprising a gas guide saddle (2022) with overpressure release (2108), locking nut (2026), mesh (2028), ribbed gasket (2032), gasket (2034) and locking ring (2036) for securing biogas tubing.

FIG. 25 illustrates gas guide saddle of FIG. 24 detailing the saddle (2102) which is configured to sit on the frame tubing, gas inlets (2104), wings (2106) configured to support biogas deflector membrane, overpressure port (2108), threaded throat (2110) and biogas nipple (2112) configured for connection to biogas tubing.

FIG. 26 illustrates an exploded view of an alternative collection hub with a collector port gas guide saddle (2022) without overpressure port, Collection Port Locking Nut (2026), locking ring (2036), combined compression ring and butyl seal (2038) and collection port mesh (2028).

FIGS. 27A and 27B illustrate a cross sectional view of the collection hub of FIG. 26 detailing venting of pressure in the biogas tubing increases. As shown in FIG. 27A, at normal pressure gas bubbles are directed to the collector port and up through the tube. As shown in FIG. 27B, at high pressure water column height in the tube is decreases, gas pressure release once the gas level reaches the bottom of the tube.

FIG. 27C is a cross sectional view of a collection hub with pressure release. The pathway of gas bubbles at high pressure is shown with arrows.

FIG. 28 is an exploded view of the access hatch (1500) of FIG. 21. The access hatch is a multi-component system comprising a sub-membrane ring (1510), supra-membrane ring (1512), O-ring (1514), door (1516) and handle assembly (1518) installed at a cut-out in the membrane.

FIG. 29 illustrates a PTU (500) having two biogas collection system having two Biogas Collectors (1000). The two biogas collectors (1000) are shown in situ in a primary treatment unit (500). The biogas collection interface (1200) of each Biogas Collector is operatively associated with a shared biogas collection system (1310). The shared biogas collection system (1310) is connected to an external gas pipe via flexible pipe (2010). Hanger assemblies (1400) and access hatch (1500) are also shown.

FIG. 30 is an exploded view of the biogas collection system of FIG. 29 detailing components of the hanger assemblies including outside wall brace (1180), inner wall brace (1182), punched HDPE strip (1184), hanger base (1186) and optional support hook (1185), components of the framework including tee (1190), HDPE tree fastener (1192), 3″ tube (1195) and 2″ tube (1196), components of the access hatch including sub-membrane ring (1510), supra-membrane ring (1512), door (1516) and handle assembly (1518). Also shown is the membrane (1201), modify end caps (1207) and buoyancy lock (1231) to prevent floating of the biogas collection system. Also shown are components of the collector port.

FIG. 31 shows two views of an alternative collector port gas guide saddle detailing fins (2114) that form the gas inlets.

FIG. 32 details a pictographic assembly manual for installation of one embodiment of the biogas collection system. In particular, Panel A details the assembled system, a biogas deflection assembly with installed port and an exploded view of the components. Panel B details the component list and the tools required for assembly including a hammer (704), drill (705), drill bit (706), utility knife (707), measuring tape (708), tightening straps (709), hand saw (710) and blocks or bricks (711). Panel C details cutting the 2″ and 3″ pipe to lengths L1, L2 and L3. Panel D details installation of end cap (1207) on center tube of framework. The end cap (1207) is secured using tree fasteners (1197) inserted into predrilled holes. Panel E details installation of the collector port gas guide saddle (2022) with tree fasteners (1197) to center tube of the framework. Panels F to K shows assembly of the framework. Panels I to K also shows partial installation of cross-bracing tube (1193). Panel L shows preparation of membrane (1201). The part of the membrane that overlays the ridge of the frame may be scored to facilitate positioning. Panels M to V show installation of membrane and configuring the framework to form the deflection paneling. Panel Y shows installation of the remaining components of the collection hub. Panel X to CC show installation of the access hatch. Panels DD to GG show assembly and installation of the hanger assemblies. Panel HH shows installation of the deflection assemblies. Panels II and JJ show installation of biogas tubing using butt fusion (BF)/SS transition (701), BF Tee (702) and BF 90° (703).

### DETAILED DESCRIPTION OF THE INVENTION

### Definitions

As used herein, the term “liquid effluent” and “liquid layer” are used to define substantially liquid portions of the sewage.

The term “sludge” is used to define substantially solid portions of the sewage.

The term “scum” is used to describe the layer which is substantially composed of materials that have a lower specific gravity than water.

Unless defined otherwise, all technical and scientific terms used herein have the same meaning as commonly understood by one of ordinary skill in the art to which this invention belongs.

### OVERVIEW

There is provided an assemble-on-site system for collecting methane-containing biogas from digesting sewage (“biogas collector” or “collection system”). The biogas collector, when assembled and installed into an appropriate primary treatment unit, provides for the deflection of methane containing biogas bubbles towards one or more collection points, and the substantial segregation of the methane-consuming scum layer from both the methane-containing biogas producing sludge layer and the point(s) of biogas collection thereby facilitating the collection of methane-containing biogas.

The assemble-on-site system for collecting methane-containing biogas from digesting sewage can be configured and sized depending on the needs and/or size and/or shape of the primary treatment unit. The biogas collector can be configured for various shaped PTUs. If the surface area to be covered by the biogas collector is substantially square or rectangular, the biogas collector may comprise a deflection assembly have a shape similar to an A-frame tent. In such embodiments, collection of biogas can be at one or more points along the tent ridge. Optionally, the tent may be angled or sloped such that the collection point is at higher level thereby facilitating movement of gas bubbles towards the collection point.

In some embodiments, the biogas collector may comprise a deflector have a shape similar to a tipi or umbrella. In such embodiments, collection of biogas is at the highest point on the collector.

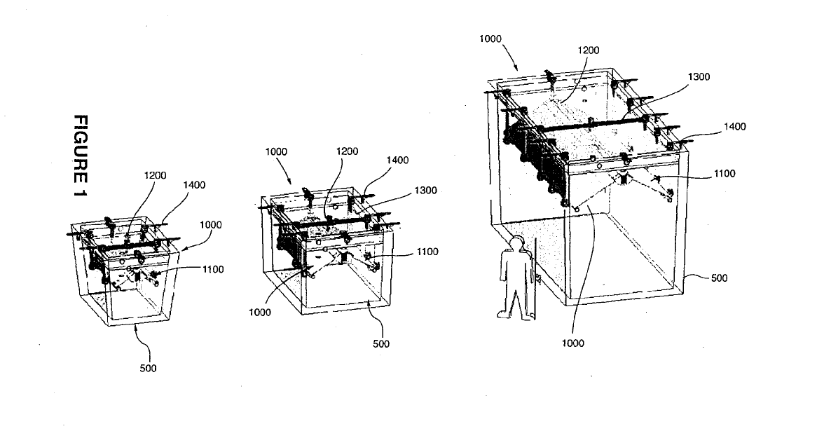

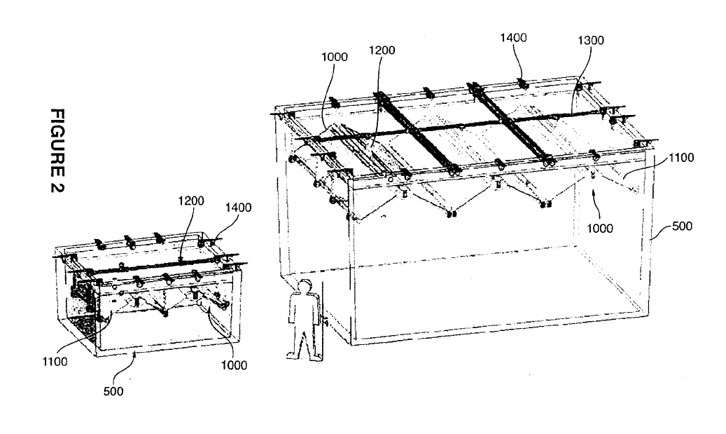

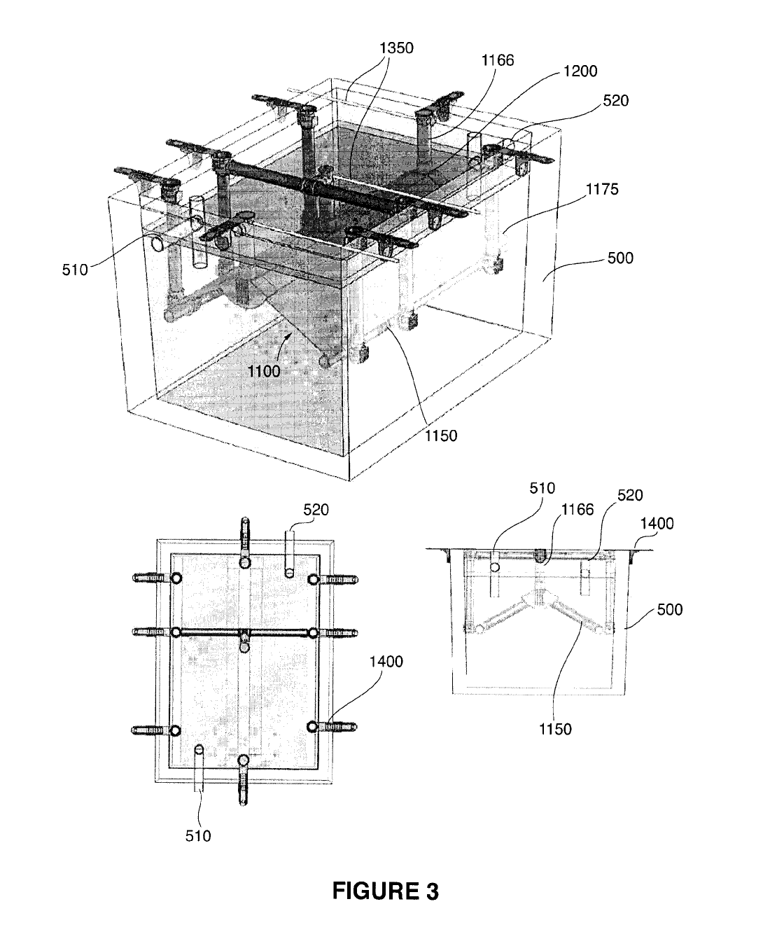

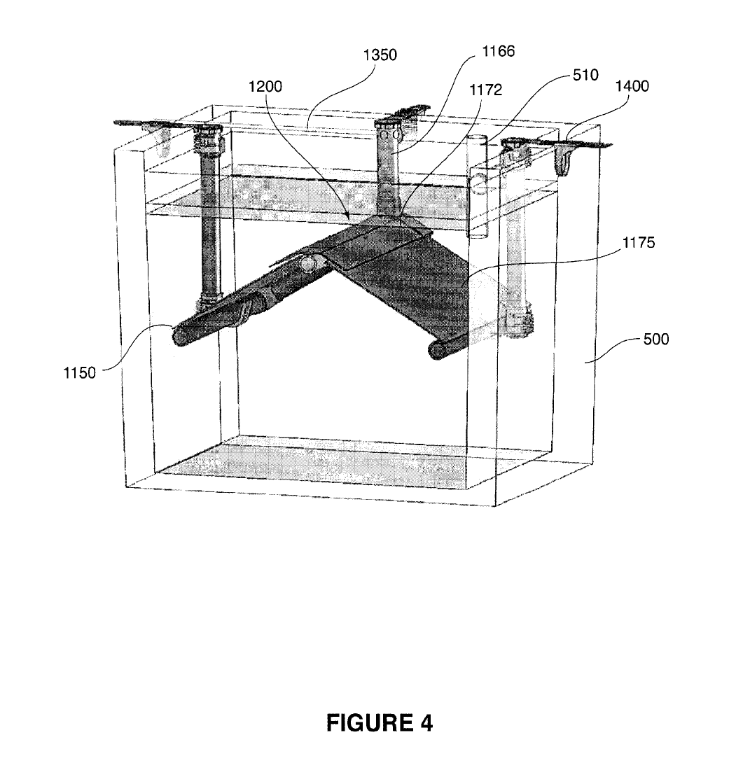

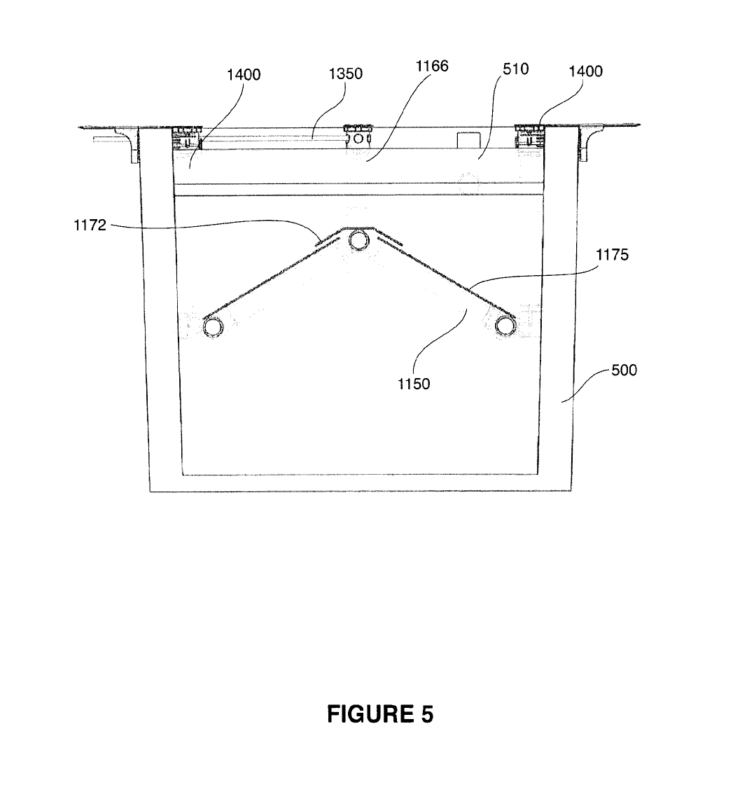

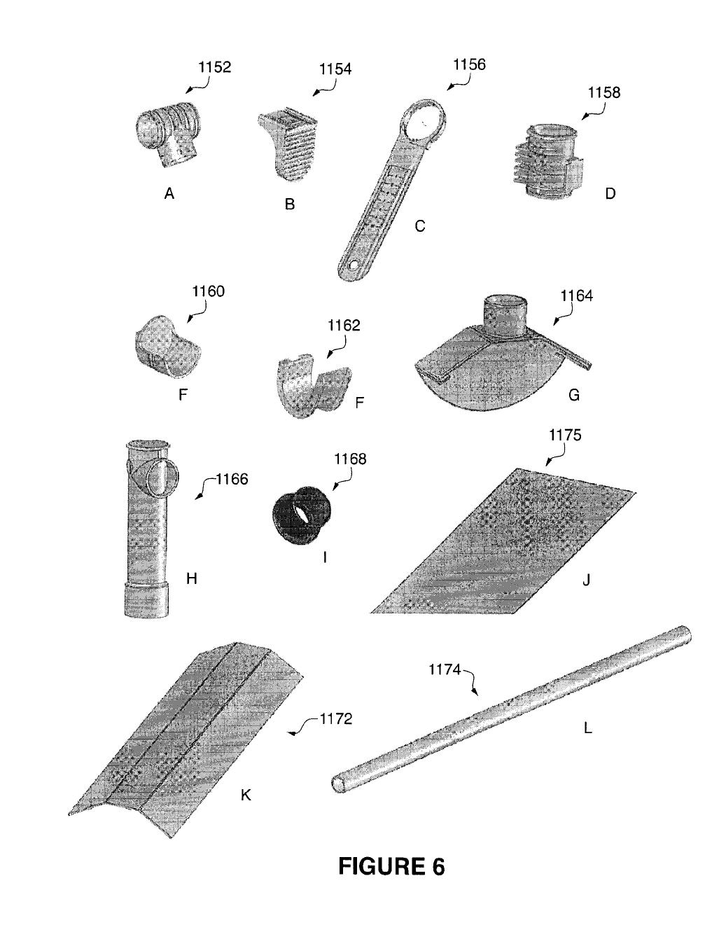

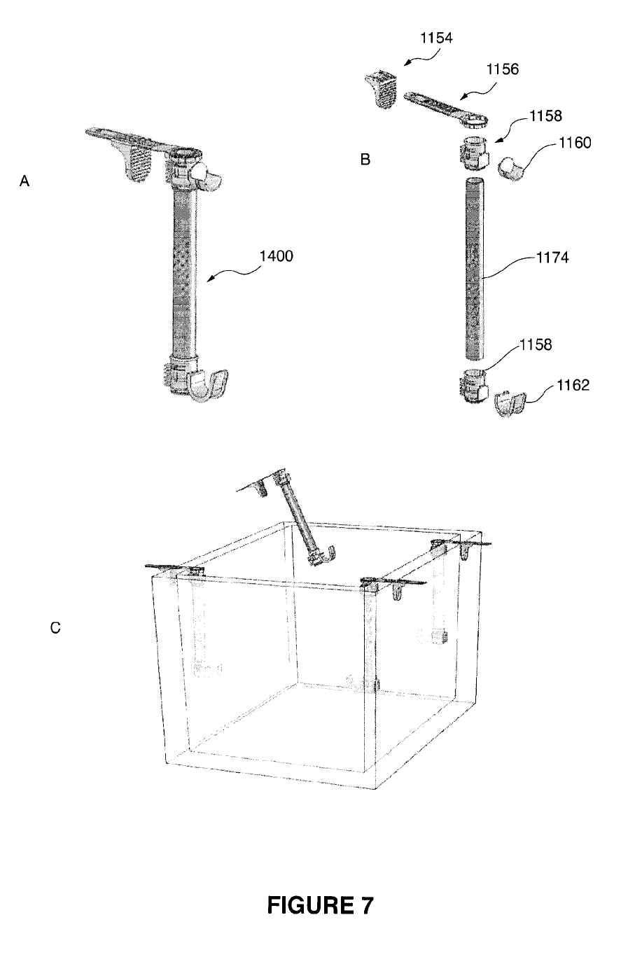

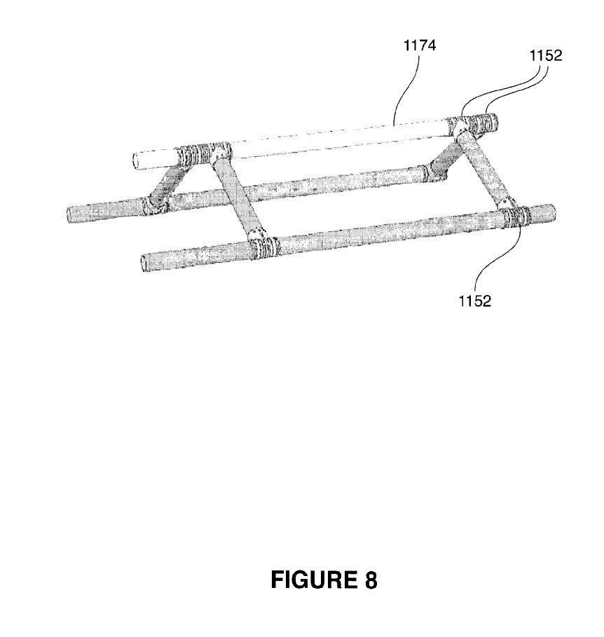

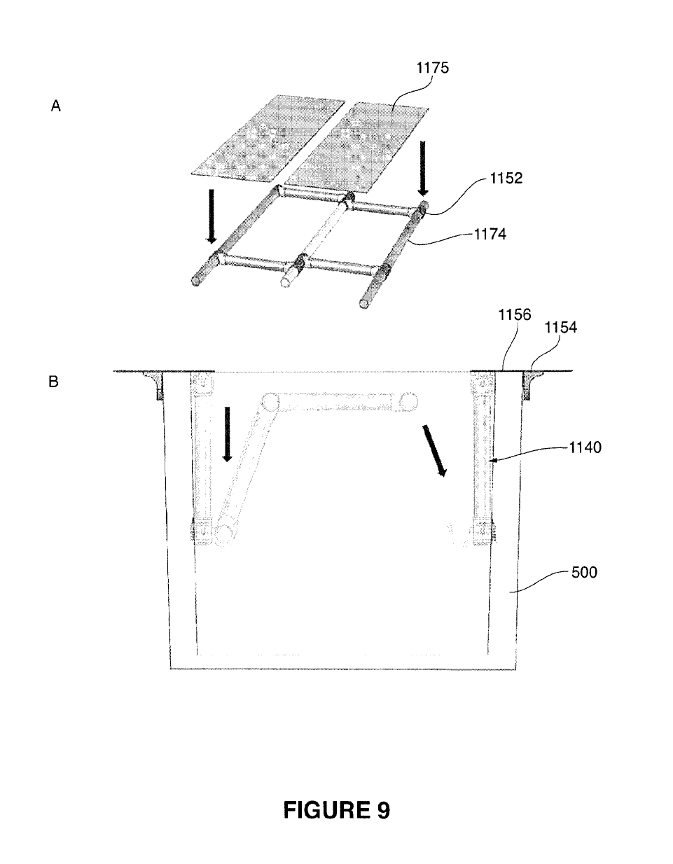

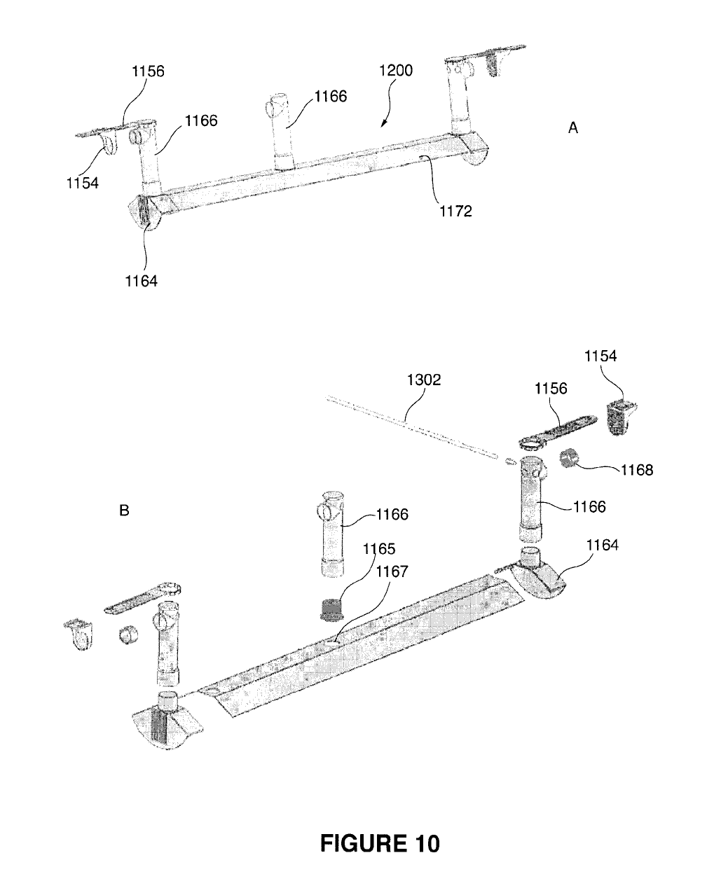

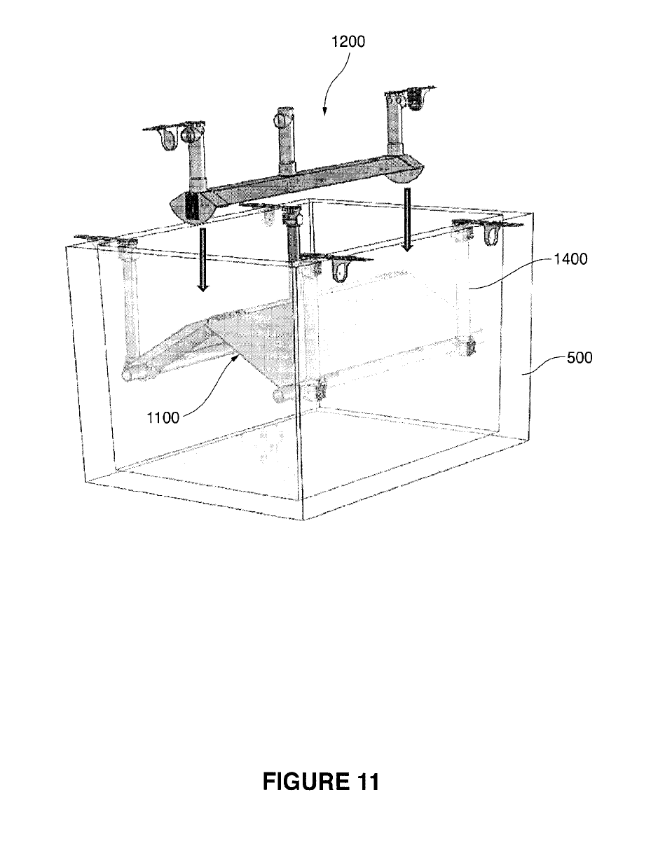

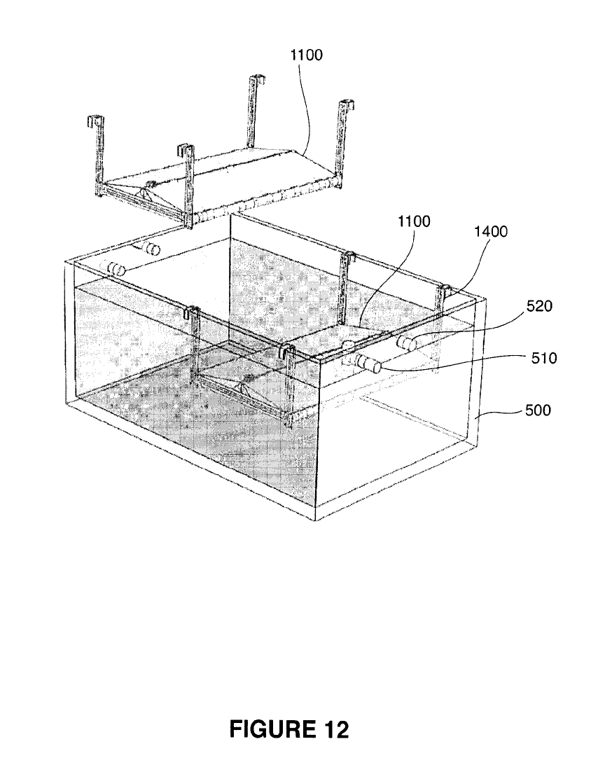

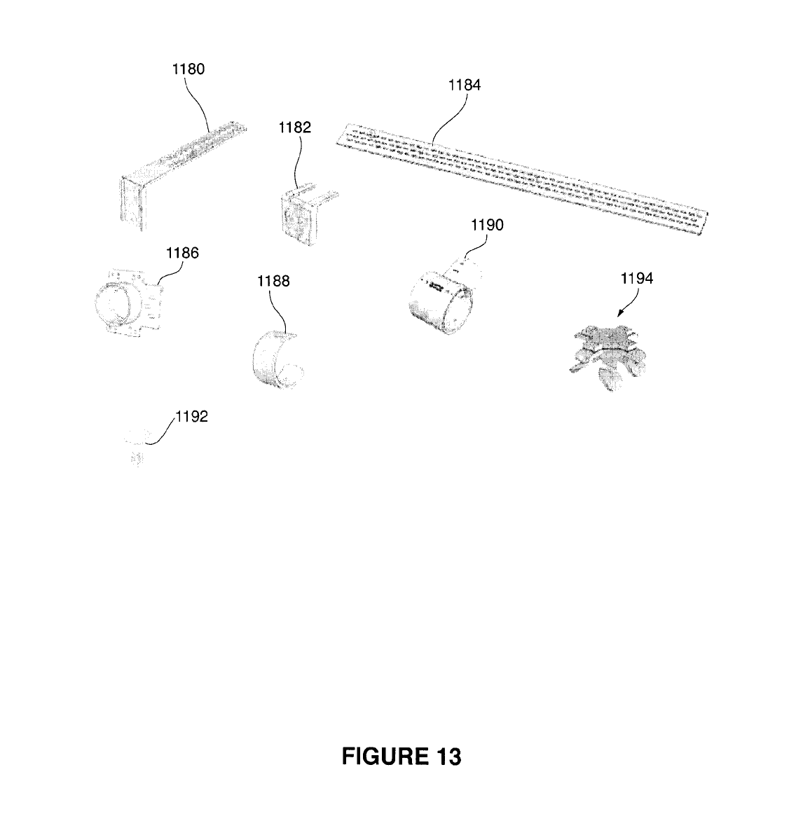

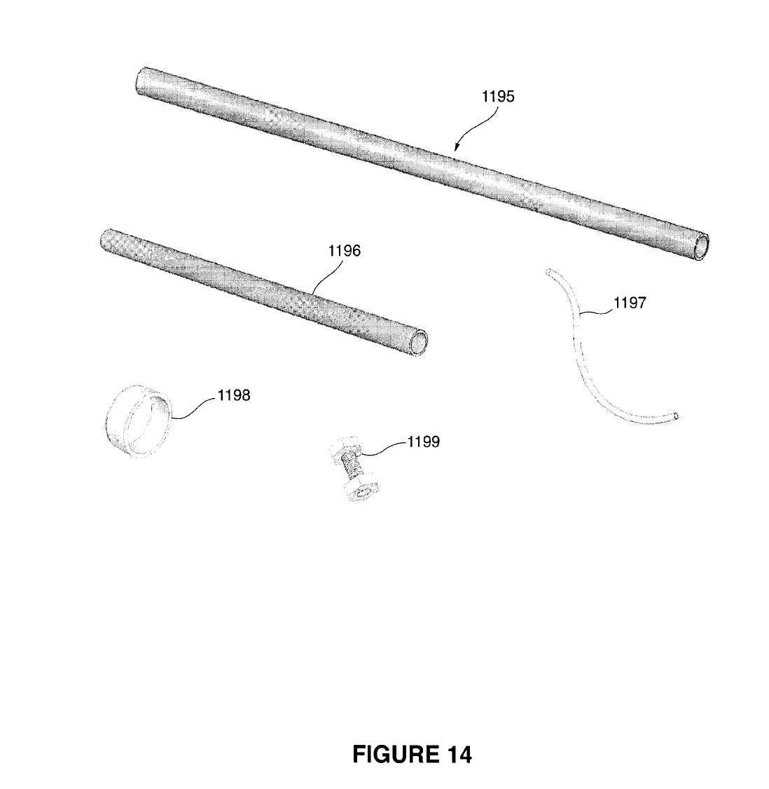

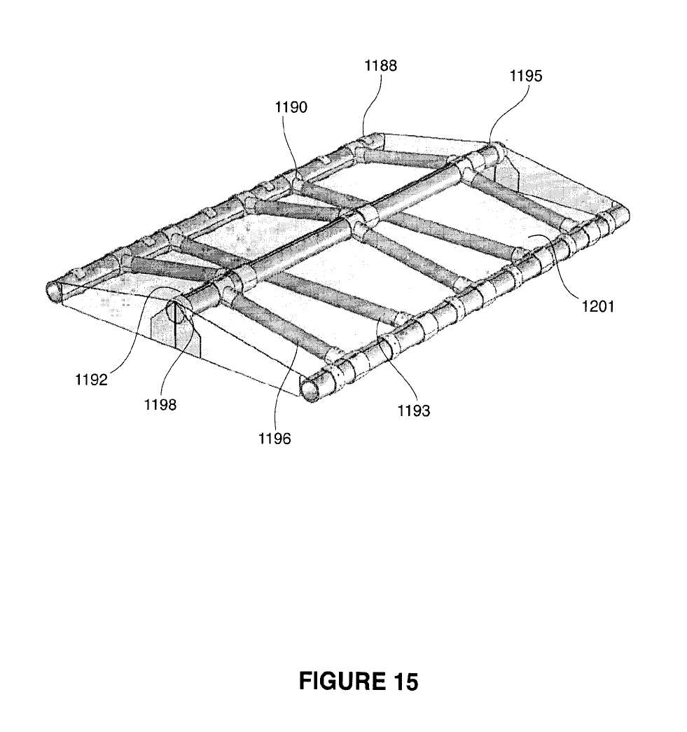

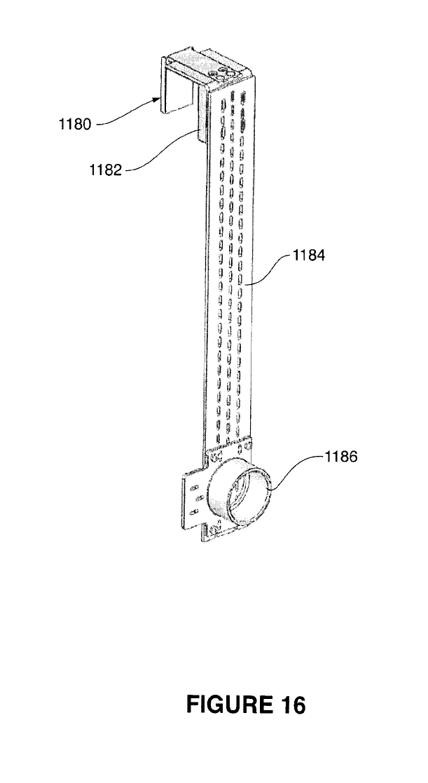

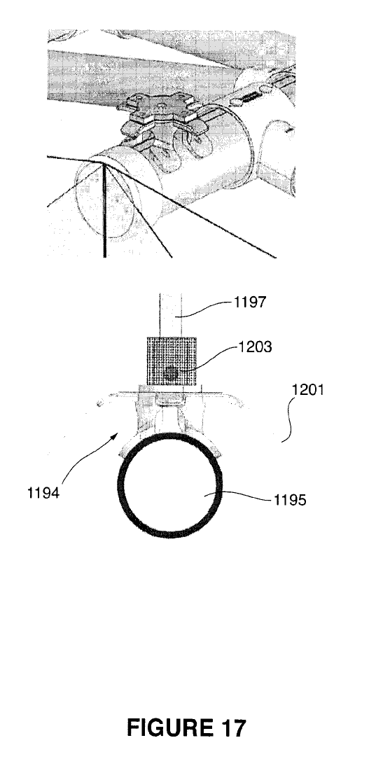

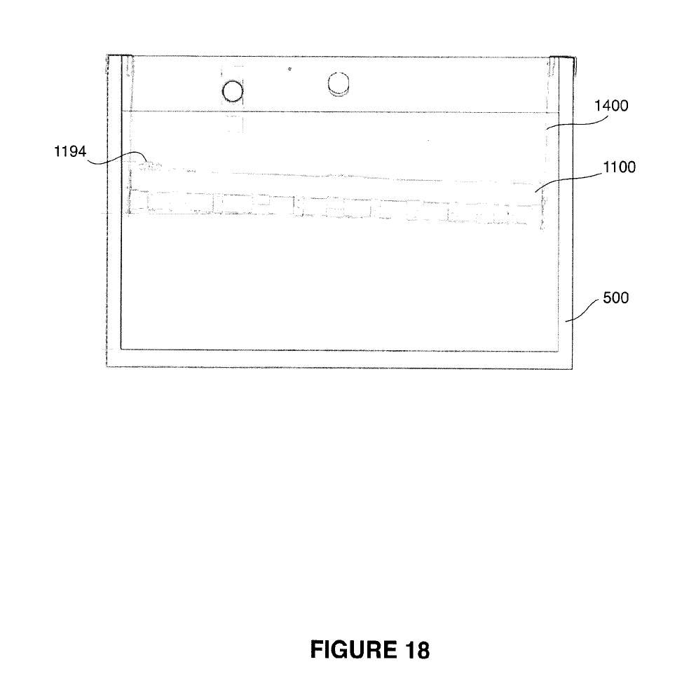

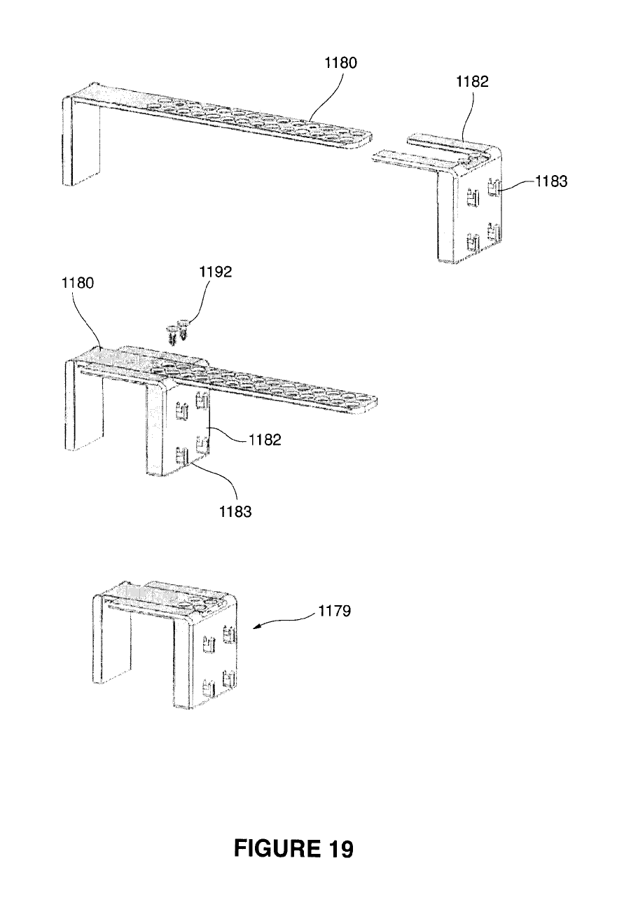

Referring to FIGS. 1 and 2, for larger primary treatment units, a single large biogas collector or multiple smaller biogas collectors can be installed to provide the necessary coverage.

In embodiments where more than one biogas collector is included in a single PTU, a seal is optionally provided between biogas collectors to prevent or reduce egress of biogas between the biogas collectors. In some embodiments, the seal is in the form of a flap of gas impermeable material that is configured to cover the junction between the Biogas Collectors. The flap of gas impermeable material is optionally weighted.

In some embodiments where a larger surface area is covered, as opposed to using multiple biogas collectors an accordion or folding assembly is used. Each peak of the accordion or folding assembly is provided with a collection interface assembly.

As noted above, each biogas collector is configured to deflect biogas bubbles towards one or more collection points. Accordingly, each biogas collector comprises a biogas deflection assembly configured and sized to fit in a primary treatment unit (PTU) and a collection interface assembly configured for connection to a biogas tubing/piping or other biogas capture or collection system. In embodiments where multiple biogas collectors are provided, the each collector may feed biogas into a shared biogas collection system which exits the PTU at a single point.

According to some embodiments, the biogas collector may be configured for retrofit into a pre-existing primary treatment unit and/or for connection to pre-existing piping network.

During operation, the biogas bubbles are deflected or redirected to collection points and enter the biogas collection subsystem via a collection interface assembly thereby avoiding the scum layer.

The biogas deflection assembly is substantially submerged below the liquid level when in operation. The collector interface assembly transits the liquid interface into the head space of the primary treatment unit and operatively associates the biogas deflection assembly with biogas tubing/piping or other biogas collection\capture systems.

According to some embodiments, the biogas collector is of a modular design with individual components configured to clip or snap together. To facilitate assembly, some components may be interconnected with, for example, shock cord, may be provided pre-assembled, or are hinged together.

The biogas collector may be provided in kit form which includes components of the system and instructions. The instructions may include sizing instructions for specific size of primary treatment unit. In some embodiments, the instructions are pictographic.

In one embodiment, the kit includes all components necessary to assemble a system for collecting methane-containing biogas. Alternatively, the kit comprises a set of custom components and details regarding components to be acquired separately. Optionally, the kit includes additional components including inlets, outlets, flow attenuation devices, and liners suitable for use in constructing a PTU.

### Biogas Deflection Assembly:

The biogas deflection assembly provides for the deflection or re-direction of biogas bubbles towards the biogas capture and/or collection subsystem and is operatively associated with the biogas collection interface. When in operation, the biogas deflection assembly is substantially submerged below the liquid effluent layer.

The biogas deflection assembly can be a variety of shapes so long as its configuration provides for the deflection of biogas bubbles to a collection point or port. Appropriate shapes include tent-shaped, tipi-shaped, dome-shaped or arch-shaped. The sites and number of biogas collection ports will depend, at least in part, on the shape of the biogas deflection assembly.

The biogas deflection assembly can be a variety of sizes and is generally sized to provide a gap or space between the lower edge of the deflection paneling and the PTU walls. In some embodiments, a cut out may be provided in the membrane or paneling of the biogas deflection assembly in line with the PTU inlet to facility the settling of solid material.

In some embodiments, the biogas deflection assembly is configured to deflect sewage or waste material that may land onto it from the PTU input. The angle or slope of biogas deflection assembly panels may be sufficient to allow solid material in the sewage or manure to slide off of the assembly towards the side walls of the PTU.

According to some embodiments, the biogas deflection assembly is weighted or configured to be secured in placed to ensure it remains submerged during operation.

The biogas deflection assembly can be provided pre-assembled, optionally in a folded or collapsed form to facilitate transport, or components thereof may be provided for on-site assembly.

The biogas deflection assembly includes a framework, biogas deflection paneling which together form the biogas deflector and hanger and/or support assembly/assemblies. The frame and/or hanger and/or support assemblies may be modular in construction. The components of the biogas deflection assembly can be constructed out of various types of material which are suitable for use in a primary treatment unit. Such materials are known in the art and include high density polyethylene (HDPE). The biogas deflection paneling is optionally provided as a membrane material. Membranes which are substantially impermeable to methane and/or biogas are known in the art.

In one embodiment, the biogas deflection assembly includes a modular framework, biogas deflection paneling and a plurality of hanger assemblies.

According to some embodiments, the biogas deflection assembly is provided with a hatch or access port to allow for maintenance of the PTU tank and desludging to occur. The hatch or access port includes a door or cover.

### Framework:

The frame assembly or framework provides support for and/or anchoring for the paneling and interfaces with the hanger assemblies and optionally the collector assembly. Design of the framework can be modified based on the shape and/or size of the primary treatment unit and the design specification of the biogas deflection assembly and may be modular in design.

The framework may be provided pre-assembled or as a set of components that can be snapped, clipped, glued or otherwise connected together. To facilitate transport, pre-assembled frameworks may be collapsible or foldable.

According to some embodiments, the framework can be assembled from prefabricated smart parts that are optionally configured to snap together or clip together, with for example, tree clips. Optionally components of the framework are glued together.

According to some embodiments, the framework can be assembled from readily available components such as tubing or the like. Alternatively, the framework may be a combination of prefabricated smart parts and readily available off the shelf components.

The framework can be constructed of a variety material suitable for use in a PTU, including, for example, high density polyethylene.

### Paneling/Biogas Membrane:

The paneling interfaces with the framework assembly and provides for the deflection of biogas bubbles. In one embodiment, the paneling may be plastic or a methane or gas impermeable membrane.

In one embodiment, the paneling is adapted to maintain heat in the sludge layer.

In one embodiment, the paneling may be constructed out of a light weight flexible membrane or sheeting that is substantially methane impermeable and optionally impermeable to other gases and volatile organic components. Appropriate membranes are known in the art and include geomembranes comprising ethylene vinyl alcohol in a linear low density polyethylene, for example, the gas impermeable film and sheet supplied by Raven Industries (Sioux Falls, S. Dak.).

According to some embodiments, the paneling is provided with gills or fins which allow for release of gas if pressure under the biogas deflection assembly exceeds a certain point.

Hanger and/or Support Assembly:

The hanger and/or support assemblies provide support for and/or anchoring for the assembled frame and deflection paneling (i.e. deflectors). Optionally, the hanger assembly locks the deflectors in position and/or prevents upward movement of the deflectors due to buoyancy.

According to some embodiments, the hanger and/or support assembly are hangers which are configured to hang over the wall of the primary treatment unit and include either a hook or other means of engaging the biogas deflectors.

In some embodiments, hangers are fixed in length and optionally of unitary construction.

Alternatively, hangers are adjustable length hangers. Adjustability may be provided by providing multiply sites for attachment of the hook or like at the lower end of the vertical support of the hanger. Adjustability of hanger length may also be provided by having a vertical support having upper and lower portions which are slidably connected to each other and which may be locked in position once the appropriate length is selected.

The element of the hanger which engages the PTU wall is optionally adjustable to account for differences in PTU wall thickness and may also include a means for locking the hanger in place.

In some embodiments, the hanger assemblies can be assembled from prefabricated smart parts that are optionally configured to snap together.

In one embodiment, the hanger assemblies or components thereof are made from high density polyethylene.

The number of hanger assemblies necessary to support the deflectors depends on a number of factors including size and weight of the deflector. A worker skilled in the art would readily be able to determine the appropriate number for a particular deflector.

The hanger may also be equipped with supports for components of the biogas collection system and/or be provided with means secure the frame to the side of the PTU tank to counter any uplift forces against the tent frame during normal operation.

In some embodiments, the supports or hangers are integrated into the PTU wall or affixed thereto.

### Collection Interface Assembly:

The collection interface assembly provides for the passive transfer of deflected biogas to the biogas collection subsystem. The collection interface assembly interfaces with the highest point(s) of the deflectors thereby maximizing the capture of methane-containing biogas from the PTU. This position takes into account that biogas is lighter than air and therefore tends to collect at the highest point. According to some embodiments, the collection interface assembly may be in the form of or comprise one or more collection hubs or ports.

The collection interface assembly includes at least one conduit or the like that crosses the hydrostatic line (liquid gas interface). In one embodiment, the size or cross sectional area of the conduit is minimized to reduce the forces necessary to cross this interface. The conduit may be made from a variety of materials including flexible tubing or tubing. In some embodiments, it is a multi-part component of the collection interface assembly.

In some embodiments, the collection interface assembly is specifically configured based on the configuration of the biogas deflector shape.

According to some embodiments, the collection interface assembly can be assembled from prefabricated smart parts that are optionally configured to snap together. Components are optionally glued together.

According to some embodiments, the collection interface assembly includes a pressure release feature.

### Biogas Collection System

The Biogas Collector is amendable for use with various biogas collection systems. The biogas collection system comprises one or more Biogas Capture and/or Collection Units (BCCU) which are configured for operative association with the collection interface assembly of the Biogas Collector, and thereby provide for the capture and/or collection of the methane-containing biogas generated in primary treatment units.

The BCCUs may be located within the PTUs or may be external to the PTUs, thus the Biogas Collector may be configured for connection to both internal and/or external BCCUs. In embodiments in which the Biogas Collector is for connection to BCCUs located external to the PTU, the collection interface assembly is configured to facilitate the transfer of biogas from the inside of the PTU to the externally located BCCUs.

The biogas collected by one or more Biogas Collectors may be combined together, for example, using a system of pipes. In such embodiments, the Biogas Collector may be specifically configured to facilitate connection to a shared biogas collection system. Alternatively, the Biogas Collectors may be configured to connection to stand-alone BCCUs.

### Tubular Conduits

The BCCUs may be conduits or a sealed piping system operatively attached to the Biogas Collector using attachment assemblies. Attachment may be direct to the Biogas Collector or indirect. A worker skilled in the art will understand that the different types of attachment assemblies as are known in the art.

Optionally, the conduit acting as the BCCU is made of High-density polyethylene (HDPE). The flexible nature of HDPE reduces the chances of shearing damage to the pipe. HDPE is also non-corrosive to the typical gases extracted from sewage and resistant to biological attack. Sealing means as are known to a worker skilled in the art.

The connection of the BCCUs to the Biogas Collector may be made using a sealingly airtight connection and may be direct or indirect.

### Reversible Capture Units

The BCCU may be a container such as a canister reversibly connected to the Biogas Collector and designed for reversible capture of the biogas generated therein. Alternatively, the BCCUs are a hybrid combination of conduits and canisters, wherein conduits operatively linked to the Biogas Collector captures the biogas generated in the PTU and transports it to removably attached canisters that reversibly capture the biogas. In such hybrid embodiments, the canisters may be located remote from the PTUs, for example at a centralized facility or site.

On saturation with captured biogas, the canister or its contents therein is dissociated from the PTU and optionally transported to a facility (e.g. the gas utilization center) where the biogas captured is extracted again for further processing, storage and/or utilization.

A variety of materials can be used within the canisters for capturing the biogas either using adsorption or other mechanisms. Some of these materials are described below. A worker skilled in the art will understand that the materials listed below are merely exemplary and other materials suitable for capture of gases as are known in the art.

Optionally, the canisters are packed with adsorbent materials. The biogas, comprising primarily of methane, is adsorbed in the pores and on the surfaces of the adsorbent medium. Methane molecules preferentially adsorb in pores having a diameter of 1.0-1.5 nm. The canister is filled with a material that has a high volume of pores less than 1.6 nm in width as a percentage of total pore volume are used.

Activated carbon has long been used for removal of impurities and recovery of useful substances from liquids and gases because of its high adsorptive capacity, wherein “activation” refers to any of the various processes by which the pore structure is enhanced. Highly microporous carbon is used within the canisters for capturing the biogas. The microporous carbon can be prepared by a variety of different techniques such as further chemical activation of activated carbon. An example of a process for preparation of highly microporous carbon is given in U.S. Pat. No. 5,626,637.

The container can also be filled with materials whose lattice structures of crystalline or grain configuration is capable of reversibly trapping the methane molecules. In one embodiment of the invention, these materials have lattice structures that permit the penetration of methane molecules to the interior of the solid mass and have an inner surface activity with respect to the methane molecule such as to allow surface adhesion at least to the extent necessary to augment the trapping effect. In one embodiment of the invention, zeolites of known cage-like lattice structure, such as mentioned in U.S. Pat. No. 4,495,900 are used.

The container can be filled with a sulphur-containing active carbon, produced from inexpensive aromatic precursors, such as chrysene, coal tar, and petroleum oils. An example of a process for producing such a material is given in U.S. Pat. No. 5,639,707.

The BCCU canisters may be filled with nanoporous carbon made from waste corn cob

### Primary Treatment Unit

The collection system is amendable (adaptable) for use in a variety of primary treatment units. Appropriate primary treatment units are known in the art and include both single and multi-chamber primary treatment units. In multi-chamber primary treatment units, the collector is installed in the chamber in which the sewage sludge collects.

The primary treatment unit (PTU) in one embodiment is a closed, leak-proof container that receives sewage from one or more sources of sewage via a sewage input system or through one or more inlet(s) and outputs liquid effluent through an outlet or via an effluent output system. The kinetic energy within the flow of sewage is dissipated and the flow is slowed so that the solid components within the inputted sewage separate and settle to form a sludge layer that supports anaerobic digestion. Less dense components of the sewage rise to the surface to form a scum layer that may support methanotrophic bacteria growth. In one embodiment, the sewage inlet(s) and/or outlet are positioned in the settling compartment or chamber to facilitate the separation of the scum layer from the methane-containing biogas producing layer and the methane-containing biogas collection points in the digestion compartment or chamber.

The PTU can be constructed out of a variety of materials including concrete, plastics including PVC and PE, fiberglass, bricks, gel coat, metal, among other materials known in the art. In one embodiment, the PTU can be made of concrete, such as high strength, reinforced concrete of at least 35 mPa (4,500 psi), but may also use any suitable material such as fiberglass, high density polyethylene (HDPE), or other materials known to a worker skilled in the art that would allow for the desired level of system sealing.

The PTU may be constructed from readily available materials including, for example, stone, earth, clay, preserved or treated wood, bricks, shipping containers or other materials that would provide the necessary structural support and lined with a watertight shell or liner. Appropriate watertight shells or liners are known in the art and include those manufactured from plastic (e.g. polyethylene); polyvinyl chloride; polyvinyl; vinyl based polymers, polypropylene. In one embodiment, the liner is a polyvinyl chloride flexible membrane. Optionally, the liner could be a spray applied liner.

The PTU can be constructed in a variety of shapes. The dimensions of the PTU are determined based on its application of use. A skilled worker will appreciate that the dimensions of the PTU are chosen to accommodate the application for which it is used. In one embodiment of the invention, the PTU is used to receive sewage from a single residence and has a volume range between 3,600-4,500 liters. A PTU used to receive sewage from a multi-residence building or industrial waste may have a higher volume.

In one embodiment, the PTU is manufactured at least in part from material indigenous to the installation site. To ensure that the locally manufactured/installed tank of indigenous materials is sealed, the tank can be lined with HDPE, rubber, EDPM or other material inserts or bladders to ensure quality control. The lid may be lined or painted as well. A sealant may be used to ensure that the insert is sealed to the leak-proof lid.

Optionally, the PTU is designed to resist microbial induced corrosions (MIC). Appropriate measures to limit microbial induced corrosion are well known in the art and include specialized concrete-surface paint and linings for concrete PTUs and additives to concrete mix. In one embodiment, specialized concrete-surface paint in the PTU headspace is applied to resist the microbial induced corrosion and/or the provision of headspace lining with flexible polyethylene materials including corrosion protection membranes.

In one embodiment, the PTU can be part of a high-performance sewer system (HPSS) such as described in WO2007036027.

### Example

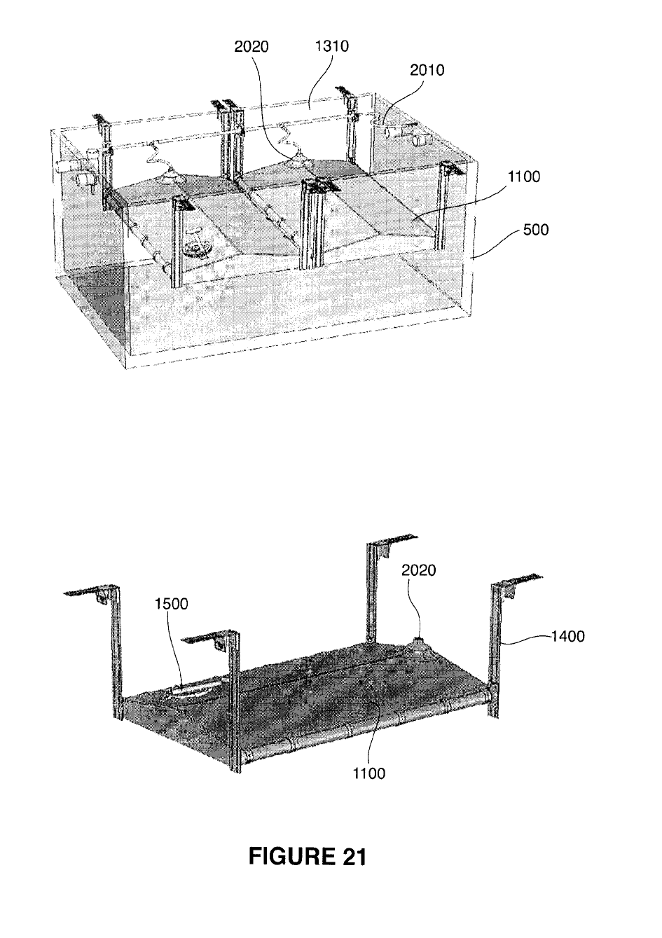

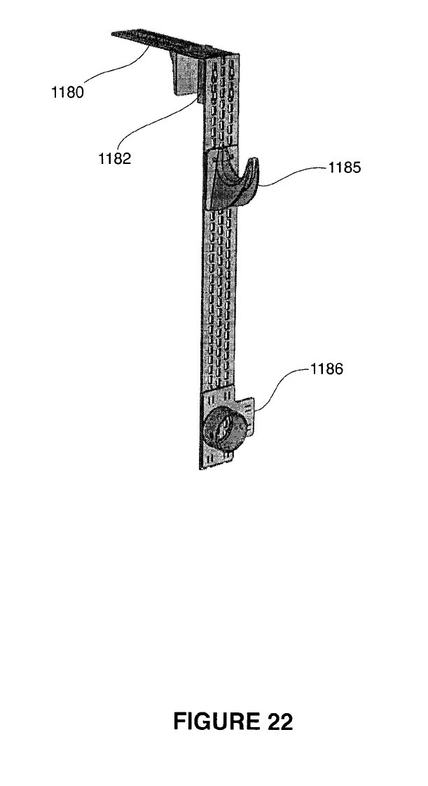

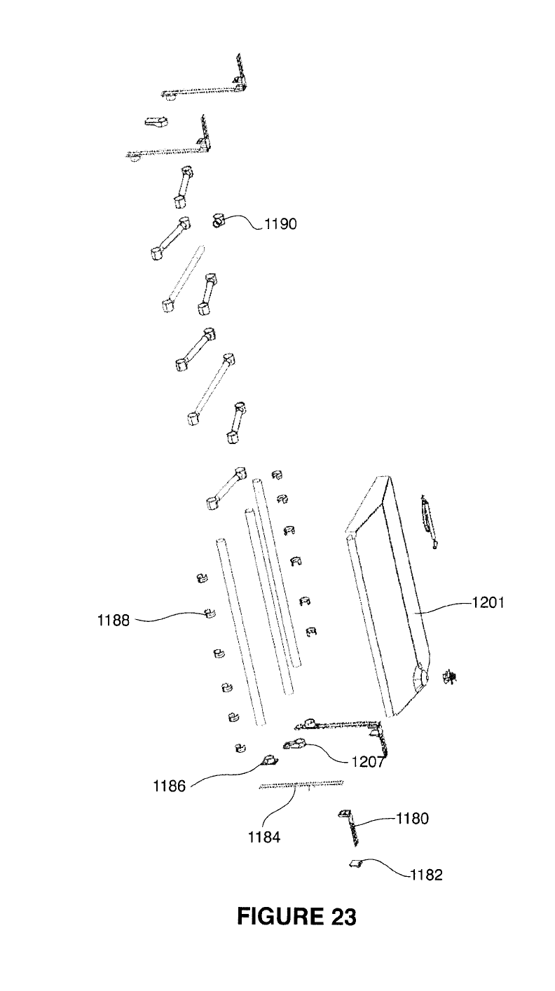

Referring to FIG. 21, two biogas collection assemblies (1000) are shown in situ in a primary treatment unit (500). The biogas collection subsystem (1300) of each collection assembly is operatively associated with a shared biogas collection system (1310). The shared biogas collection system (1310) is connected to an external gas pipe via flexible pipe (2010).

The individual biogas collectors (1000) comprise a biogas deflection assembly and a collection interface assembly which connects to the shared biogas collection subsystem (2000).

Each collection assembly comprises a biogas deflection assembly and associated collection interface assembly (1200). The individual deflection assembly includes a biogas deflector (1100) and a plurality of hanger assemblies.

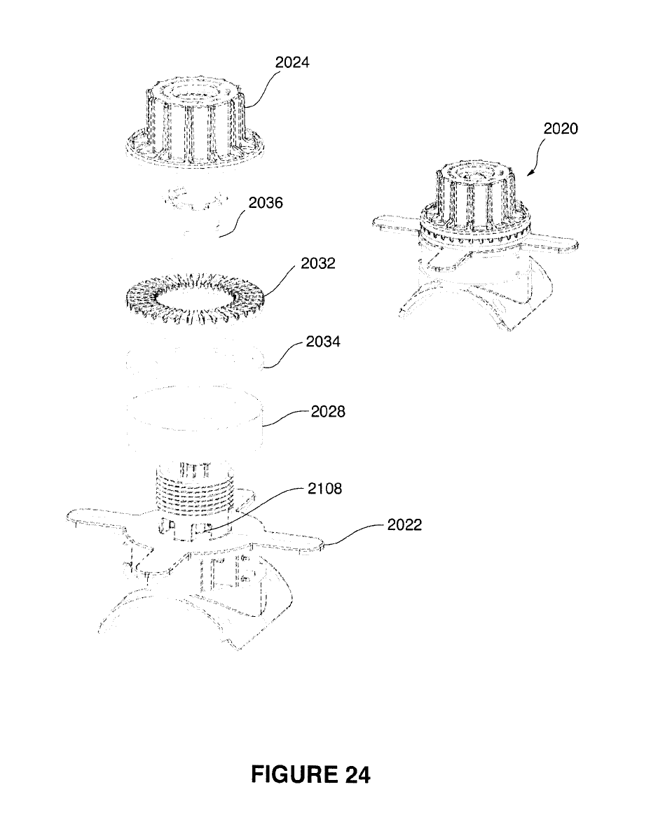

In the illustrated embodiment, the collection interface assembly is a biogas collection hub (2020) (also called a collector port system) that provides connection between the biogas deflection assembly (3000) and the piping of the biogas collection subsystem (2010). Referring to FIG. 24, the biogas collection hub (2020) is a multi-component system comprising a collector port gas guide saddle (2022) with overpressure release (2108), collection port locking nut (2026), collection port mesh (2028), collection port ribbed gasket (2032), collection port gasket (2034) and locking ring (2036) for securing biogas tubing.

In the illustrated embodiment, the collector port gas guide saddle (2102) is configured to be secured to frame tubing that forms the ridge or apex of deflector. Accordingly, the configuration of the collector port gas guide saddle will, at least in part, depend on the deflector framework configuration. During operation, biogas enters the collector port gas guide saddle through gas inlets (2104) located just below the membrane supporting wings (2106). The gas inlets are optionally provided with mesh (2028) to prevent large particulate from entering the biogas tubing. The gas inlets (2014) are in gaseous communication with the biogas nipple (2112) thereby providing a biogas corridor allowing for the transit of biogas from the points of collection to the biogas tubing. To reduce strain on the membrane, the supporting wings may be flexible. In some embodiments, alternative membrane supports means or configurations are provided.

The biogas collection hub (2020) is secured onto a roughly cut hole in the membrane and the hub components are fasten around both sides of the membrane to create a good seal. To facilitate installation of the illustrated embodiment, the port gas guide saddle includes a threaded throat (2110) to allow all components of the hub to be compressed and secured with the collection port locking nut (2026). Unwanted egress of gas is prevented by use of a flexible gasket (2034). A ribbed gasket (2032) is provided to ensure that biogas piping is appropriately seated against the saddle if piping not cut flat exactly. In some embodiments, the flexible gasket and ribbed gasket are replaced with a compression ring and butyl seal. Biogas tubing is attached to the collector gas guide saddle via the biogas nipple (2112) and secured in place with the locking ring (2036). The collection port locking nut (2026) is threaded to Gas Guide Saddle and applies even pressure on the gaskets to seal the collection port to the membrane. As the collection locking nut is tightened, the locking ring wedges into the biogas tube to secure it in place.

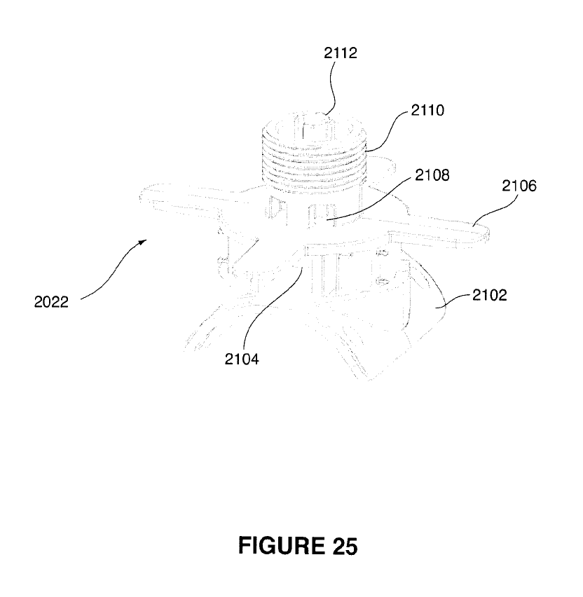

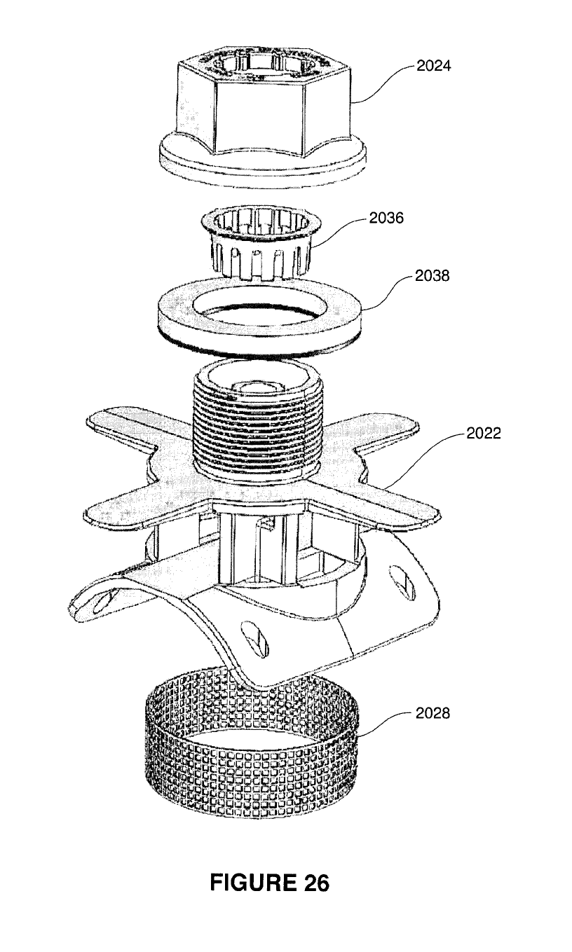

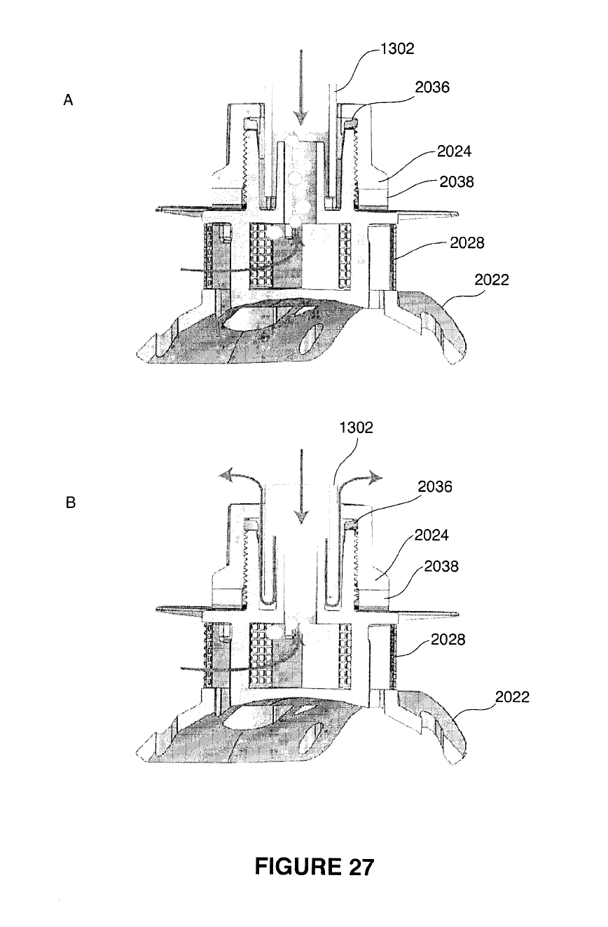

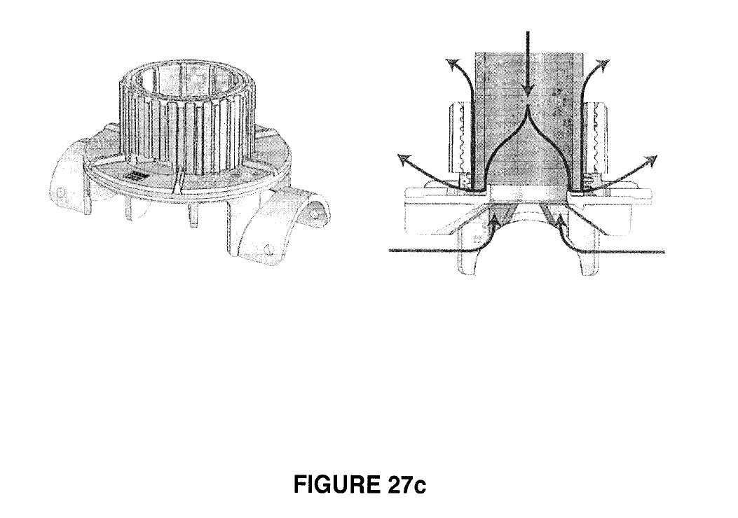

Referring to FIGS. 24 and 25, the collection hub includes a piping system overpressure feature to allow, at a predetermined pressure setting, excess biogas to vent off. The piping system overpressure feature is based on water column height. Below the set point, gas bubbles are directed to the collector port and up through the biogas tubing. If gas pressure exceeds the set level, excess gas is vented off through openings (i.e. overpressure release (2108)) in the body of the gas saddle.

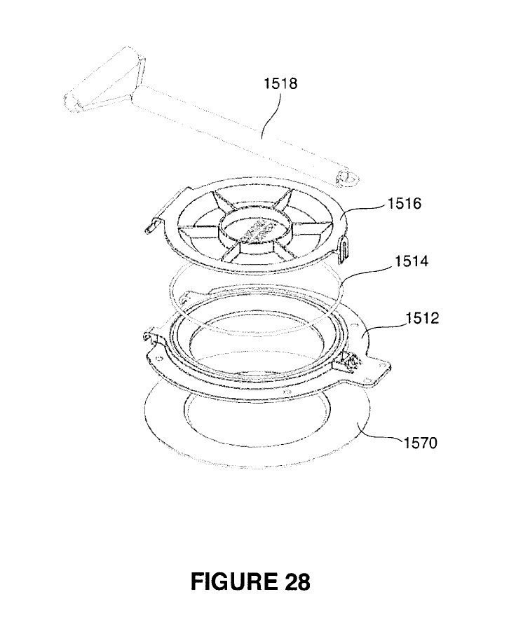

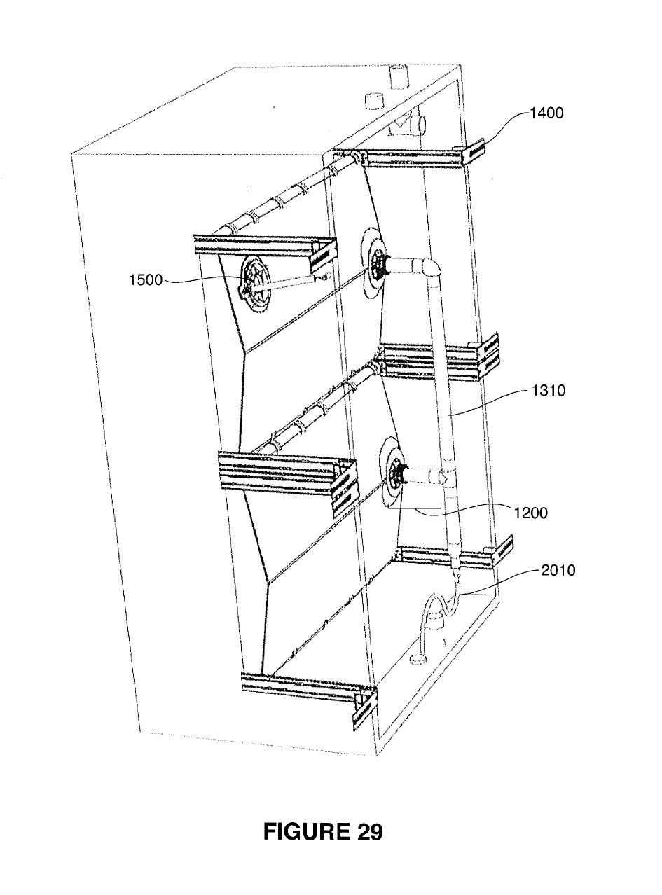

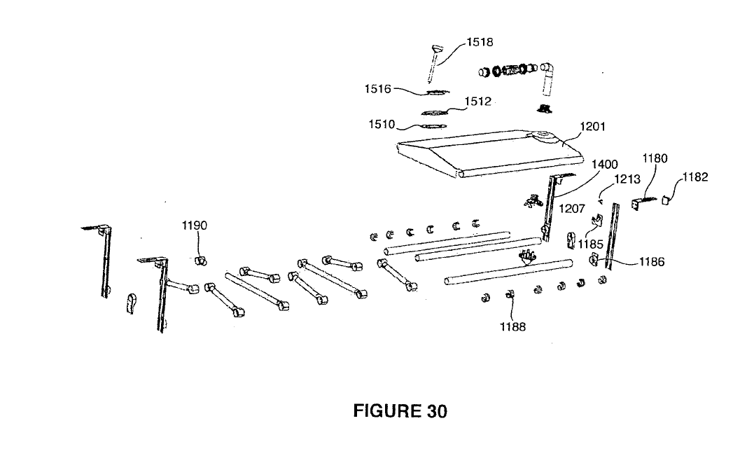

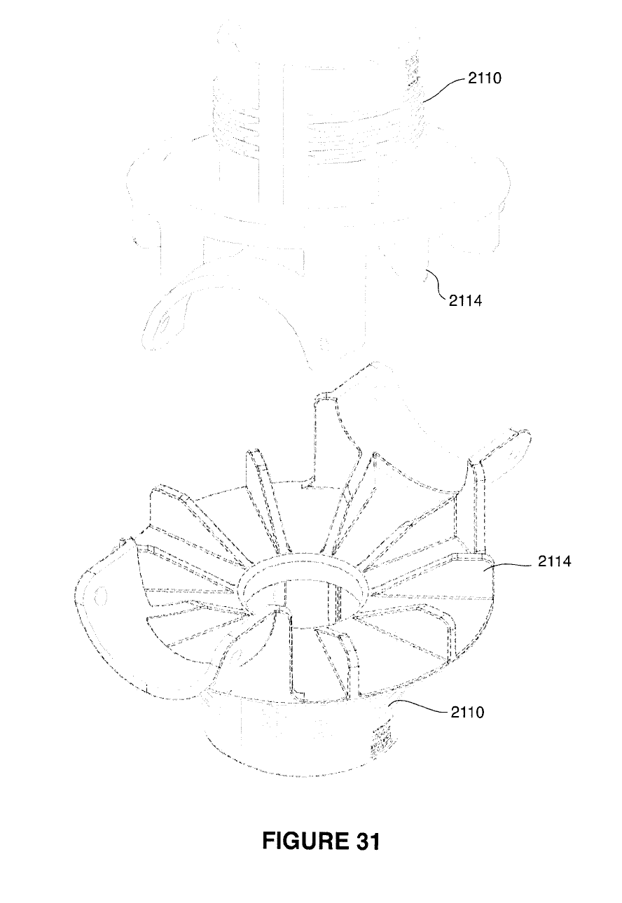

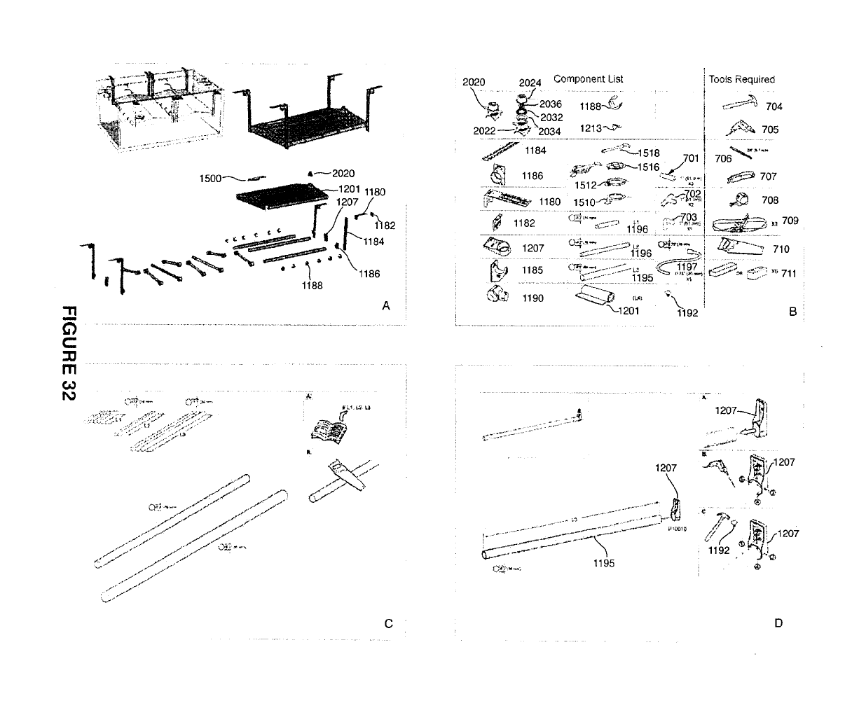

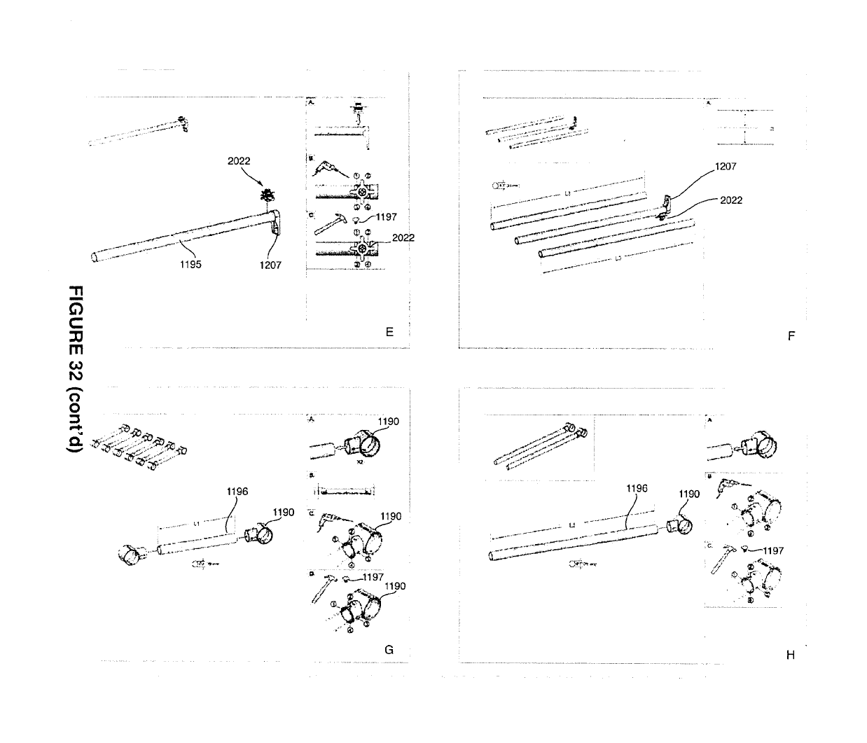

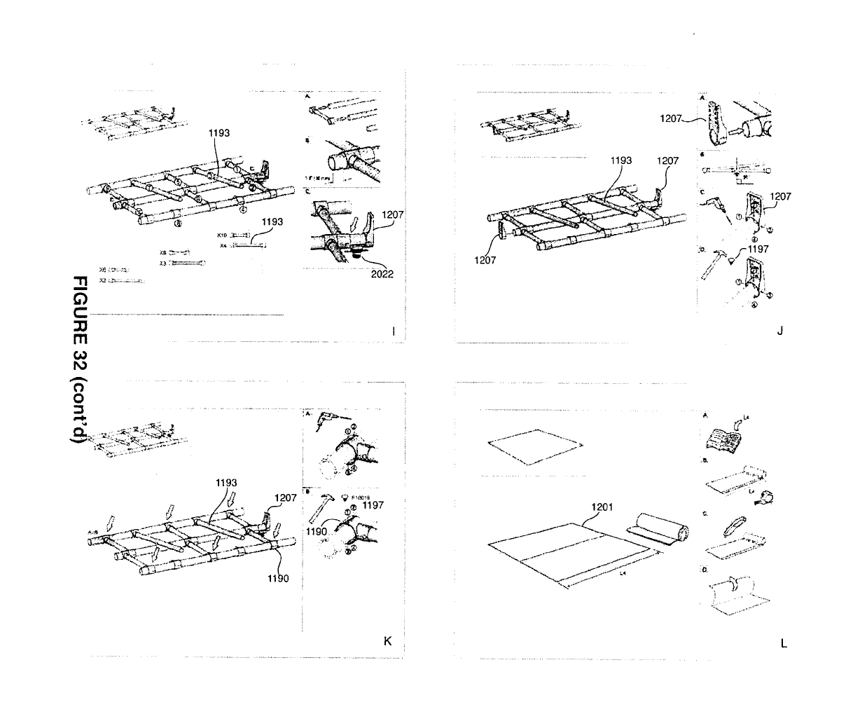

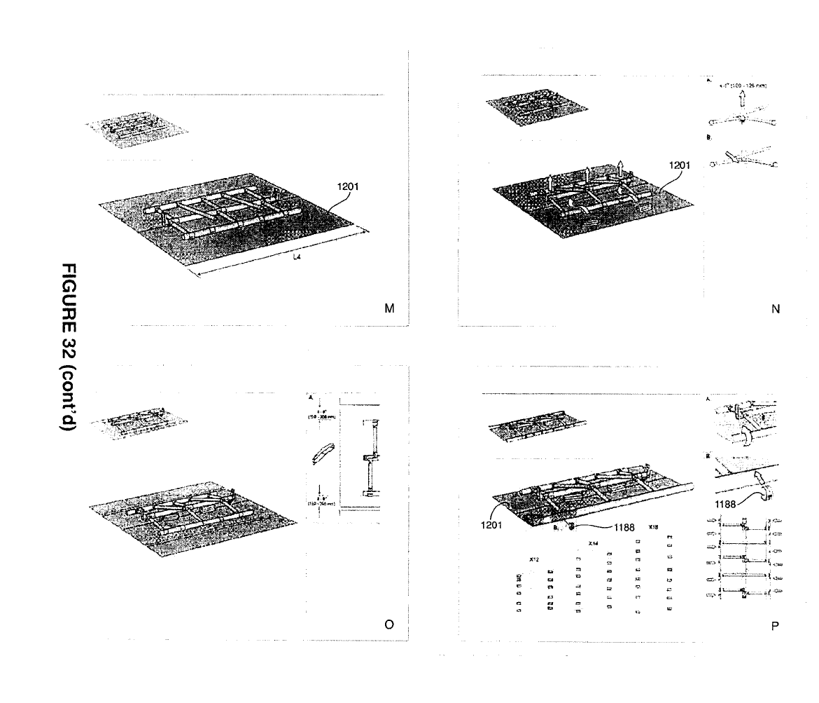

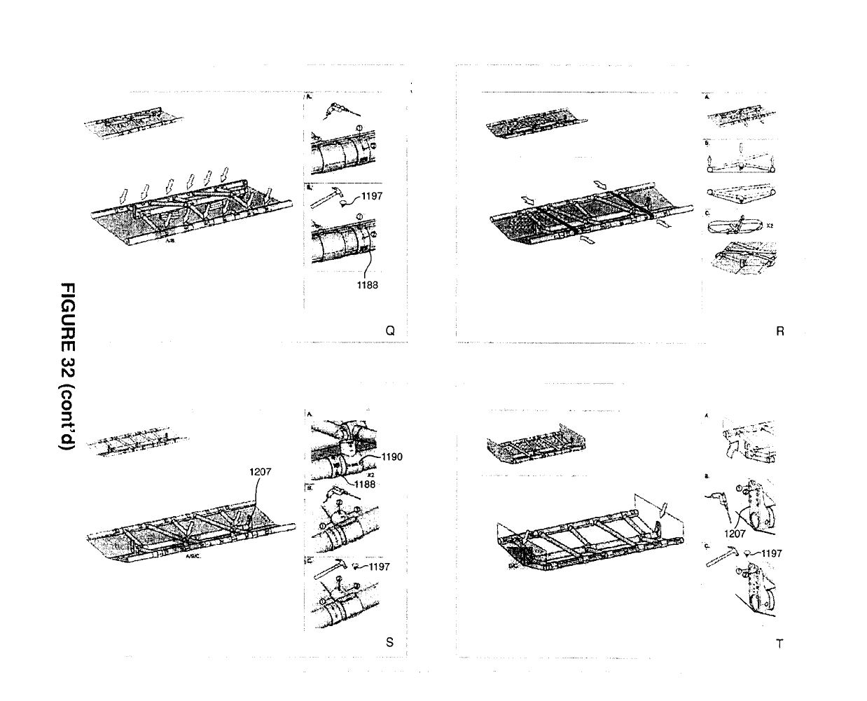

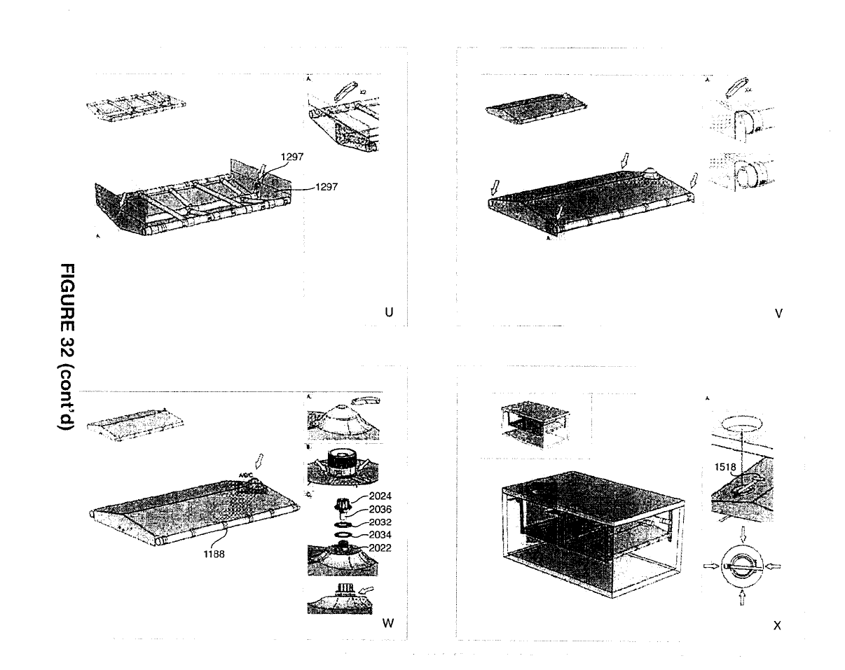

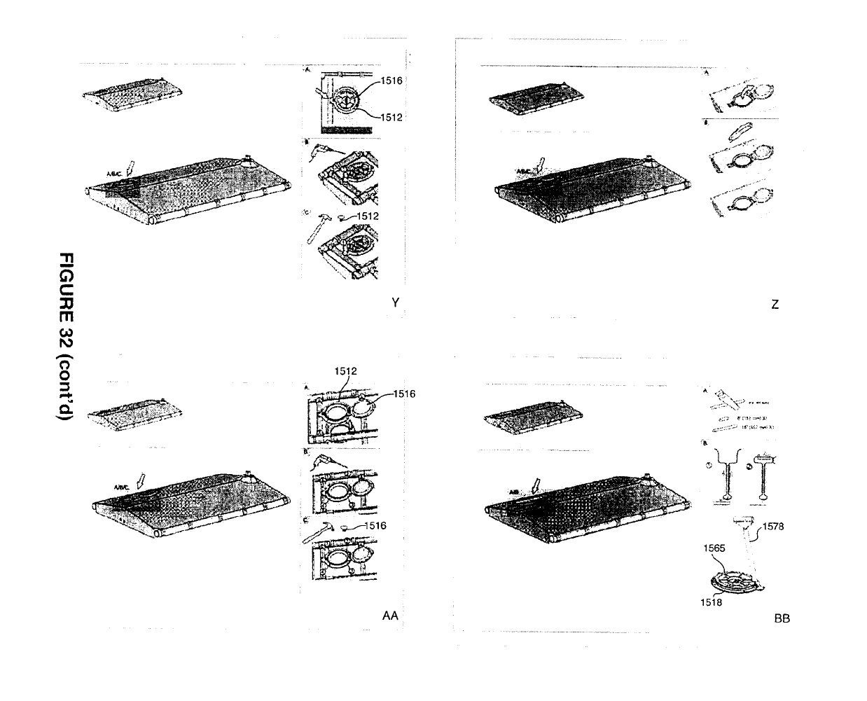

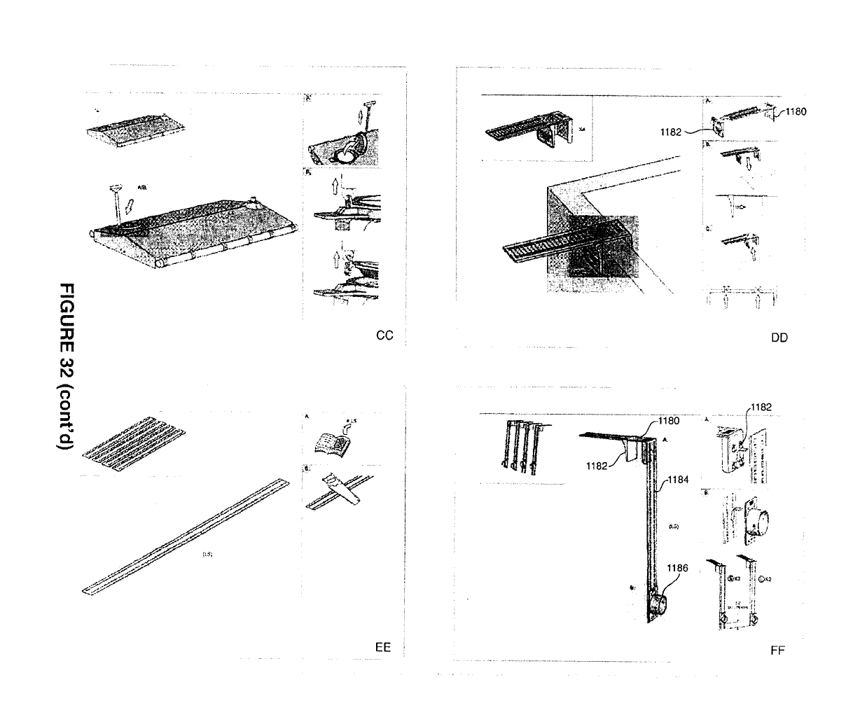

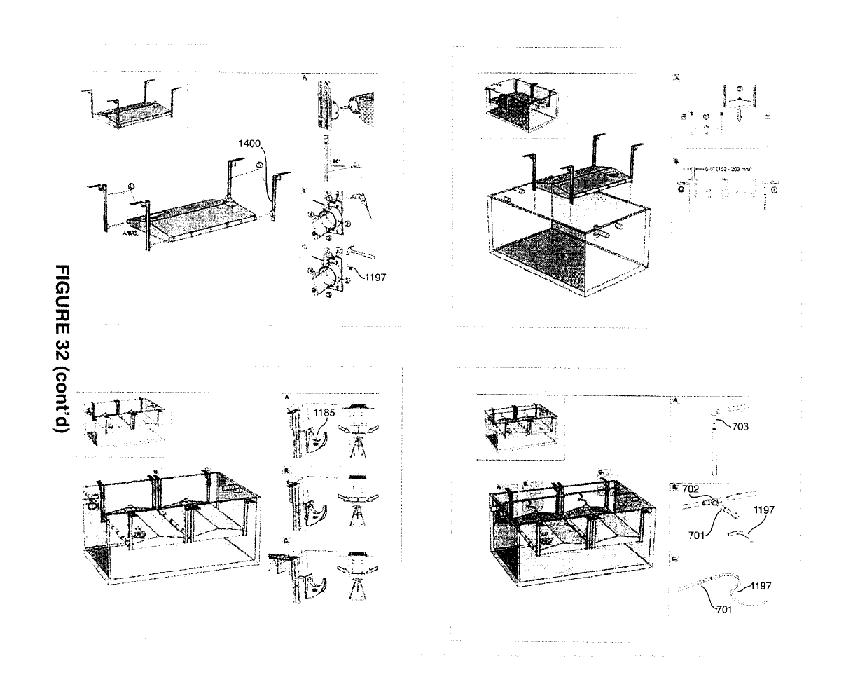

Referring to FIG. 28, an access hatch is provided in the biogas deflection assembly. The access hatch is optionally placed near the tank's access port to allow for maintenance of the biogas tank and desludging. According to some embodiments, the handle assembly (1518) of the access hatch (1500) is configured such that it floats on the surface of the tank thereby facilitating it location years later during desludging schedules. In the illustrated embodiment, the access hatch is a multi-component system comprising a sub-membrane ring (1510), supra-membrane ring (1512) O-ring (1514), door (1516) and handle assembly (1518) installed at a cut-out in the membrane. When installed, the sub-membrane ring (1510) and supra-membrane ring (1512) sandwich the membrane together thereby providing a rigid support frame to which the access hatch door is attached. The access hatch is configured such that the frame is flush with the membrane so biogas bubbles continue to flow up to the collection port uninterrupted.

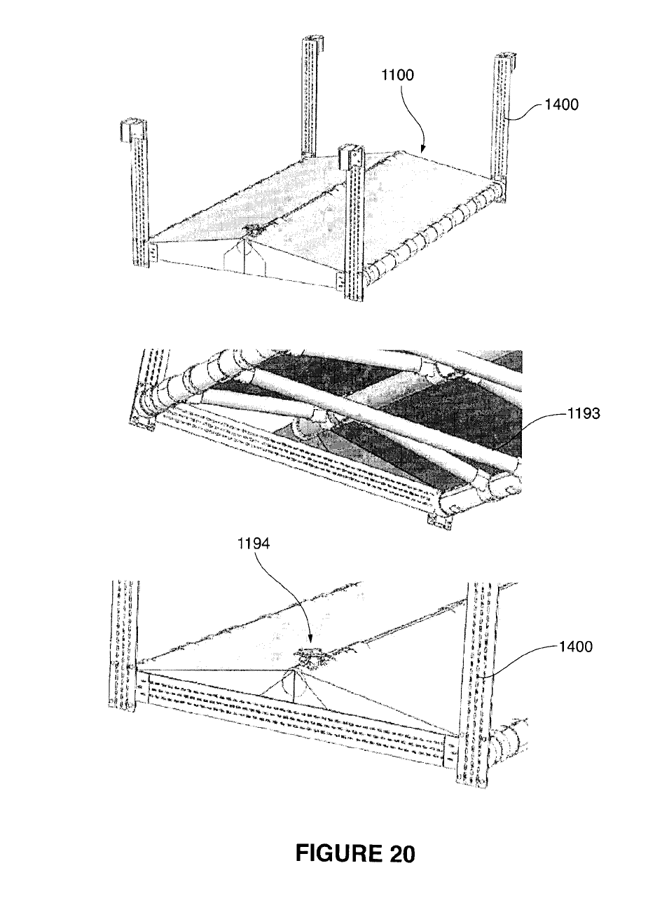

Referring to FIGS. 20 and 21, the each collection assembly is assembled as follows:
1. Membrane and tubing is cut to the appropriate sizes based on design specification.
2. Tees are attached to the ends of the short 2″ tubes and slide onto 3″ tubes. Tees for the longer 2″ tubes are slid between the shorter 2″ tube assemblies.
3. Tree fasteners are installed on the outside tees at pre-drilled holes. The collector port saddle is installed on one end of the center 3″ tube and secured with tree fasteners.
4. Endcaps are placed on each end of the center 3″ tube.
5. The assembled frame is placed on top of fabric upside down. The center 3″ tube is raised to form a V-profile.
6. The membrane material is rolled around one of the outside 3″ tubes and secured using clips and tree fasteners. The membrane material is pulled tight and attached to the opposite outside 3″ tube.
7. Excess membrane material is removed. The frame is pressed down to invert the V-profile and frame is cross-braced with 2″ tubing.
8. The hanger assemblies are assembled. The outer (1180) and inner wall brace (1182) components of the slide wall brace are slid together to an appropriate width and secured together using tree fasteners (1192).
9. Excess plastic is removed. The punched strip (1184) is secured to the slide wall brace and the hanger base (1186) secured there to.
10. Excess membrane around each end of the outside 3″ tubes is trimmed and the hangers are installed to the biogas deflection assembly and secured with tree fasteners.
11. Optionally, punched strips are measured cut and installed on the both the inside and outside of the biogas deflection assembly with nuts and bolts, securing the strip to hanger bases at both ends.
12. The remaining components of the collector port are installed and flexible tubing secured thereto.
13. The flexible tubing is attached to the shared biogas line.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

1. An assemble-on-site system for collecting biogas from digesting sewage comprising:
a biogas deflection assembly configured and sized to fit a primary treatment unit; and
a collection interface assembly operative associated with the biogas deflection assembly and configured for connection to a biogas capture or collection system;
wherein, when installed in the primary treatment unit, the biogas deflection assembly is substantially submerged and provided for the deflection of biogas to point(s) of biogas collection in the collection interface assembly.

2. The system for collecting biogas of claim 1, wherein the biogas deflection assembly comprises a biogas deflector and a plurality of hanger assemblies.

3. The system for collecting biogas of claim 2, wherein the biogas deflector comprises a framework and biogas deflection paneling.

4. The system for collecting biogas of claim 3, wherein the biogas deflector is test-shaped, tipi-shaped, dome-shaped or arched shaped.

5. The system for collecting biogas claim 1, wherein the biogas deflection assembly and/or the collection interface assembly is modular in construction.

6. The system for collecting biogas of claim 3, wherein the biogas deflection paneling comprises gas or methane impermeable membrane.

7. The system of claim 1, wherein collection interface assembly comprises one or more collection hubs or ports.

8. The system of claim 7, wherein the collection hub is a multi-part component.

9. The system of claim 8, wherein the collection hub comprises a collector port gas guide saddle, locking ring, at least one gasket and a collection port locking nut.

10. The system of claim 1, wherein the biogas deflection assembly and/or the collection interface assembly comprise a means to a vent or release biogas at high pressure.

11. The system of claim 10, wherein the means to vent or release biogas comprises pressure release gills or slits in the biogas deflection assembly.

12. The system of claim 10, wherein the collection interface assembly comprises a means to release biogas.

13. The system of claim 12, wherein the collection interface assembly comprises a collection hub with biogas tubing attached thereto and the means to release biogas is a port in the collection hub configured to release biogas at or below a specific water column height in the biogas tubing.

14. The system of claim 1, wherein the biogas deflection assembly comprises an access port or hatch.

15. The system of claim 14, wherein the access hatch comprises a door and handle assembly and wherein the handle is optional buoyant.

16. The system of claim 13, wherein the collection hub comprises a collector port gas guide saddle and the overpressure port is a port in the throat of the collector port gas guide saddle.

17. The system of claim 16, wherein collector port gas guide saddle comprises membrane support wings.

18. A kit comprising one or more components of the system of claim 1 and instructions.

19. The kit of claim 18, wherein the instructions are pictographic instructions.

20. A system for producing and collecting biogas comprising a primary treatment unit operatively associated with a source of sewage, the system of claim 1 installed therein and a biogas capture or collection system operatively associated with said system.

21. The system of claim 1, wherein the system is configured for connection to biogas pipe network.
